(19) United States
(12) Patent Application Publication
(10) Pub. No.: US 2024/0259896 A1
(43) Pub. Date: Aug. 1, 2024

(54) PARTIAL TCI ACTIVATION FOR L1/L2 BASED FAST MOBILITY

(71) Applicant: QUALCOMM Incorporated, San Diego, CA (US)

(72) Inventors: Changhwan PARK, San Diego, CA (US); Jelena DAMNJANOVIC, Del Mar, CA (US); Jae Ho RYU, San Diego, CA (US); Yan ZHOU, San Diego, CA (US); Mohamed Atef Abdelazim SHEHATA, Lannion (FR); Tao LUO, San Diego, CA (US)

(21) Appl. No.: 18/417,815

(22) Filed: Jan. 19, 2024

Related U.S. Application Data
(60) Provisional application No. 63/482,019, filed on Jan. 27, 2023.

(51) Int. Cl. H04W 36/00; H04L 5/00; H04W 36/08

(52) U.S. Cl. CPC H04W 36/0072; H04L 5/001; H04W 36/08

(57) ABSTRACT

A method for wireless communication at a user equipment (UE) and related apparatus are provided. In the method, the UE monitors a serving cell through one or more active transmission configuration indication (TCI) states of the serving cell, and monitors a reference signal associated with one or more partially active TCI states of a non-serving cell for lower-layer triggered mobility (LTM). The UE further performs the LTM handover to change the serving cell in response to an LTM command and based on at least one of the partially active TCI states and the active TCI states. The method enables the UE to use a partially active TCI state to monitor a reference signal of candidate cells for LTM. It substantially reduces the LTM HO delay and interruption length during an LTM HO. Hence, it improves the efficiency of wireless communication.

### CROSS REFERENCE TO RELATED APPLICATION(S)

This application claims the benefit of and priority to U.S. Provisional Application Ser. No. 63/482,019, entitled “PARTIAL TCI ACTIVATION FOR L1/L2 BASED FAST MOBILITY” and filed on Jan. 27, 2023, which is expressly incorporated by reference herein in its entirety.

### TECHNICAL FIELD

The present disclosure relates generally to communication systems, and more particularly, to wireless communication with transmission configuration indication (TCI) activation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to monitor a first cell through one or more active TCI states of the first cell. The first cell may be a serving cell of the UE. The at least one processor may be further configured to monitor a reference signal associated with one or more partially active TCI states of a second cell for lower-layer triggered mobility (LTM), where the second cell is a non-serving cell of the UE, and perform the LTM handover (HO) to change the serving cell from the first cell to the second cell in response to an LTM command indicating an LTM HO and based on at least one of the partially active TCI states and the active TCI states.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to transmit, to a UE, one or more active TCI states. The UE may be configured to monitor a reference signal associated with one or more partially active TCI states of a second cell for LTM. The first cell may be a serving cell of the UE, and the second cell may be a non-serving cell of the UE. The at least one processor may be further configured to transmit an LTM command indicating an LTM HO to the UE to cause the UE to perform the LTM HO to change the serving cell from the first cell to the second cell in response to the LTM command and based on at least one of the partially active TCI states and the active TCI states.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example beam management.

FIG. 4B is a diagram illustrating an example inter-cell beam management.

FIG. 5 is a diagram illustrating an example cell configuration.

FIG. 6 is a diagram illustrating a system model of an example cell configuration.

FIG. 7 is a diagram illustrating an L3-based handover (HO) delay.

FIG. 8 is a diagram illustrating an L3-based conditional HO delay.

FIG. 9 is a diagram illustrating an example of intra-frequency lower-layer triggered mobility (LTM) HO, in accordance with various aspects of the present disclosure.

FIG. 10 is a diagram illustrating the transmission configuration indication (TCI) states during an example of intra-frequency LTM HO, in accordance with various aspects of the present disclosure.

FIG. 11 is a call flow diagram illustrating a method of wireless communication in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a network entity in accordance with various aspects of the present disclosure.

FIG. 15 is a flowchart illustrating methods of wireless communication at a network entity in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

In wireless communication, user equipment (UE) may monitor synchronization reference signals, such as synchronization signal block (SSB) and channel state information reference signals (CSI-RS), for time and frequency tracking from potential candidate cells in preparation for lower-layer triggered mobility (LTM). However, continuously monitoring these signals may result in significant resource consumption for the UE. Hence, methods and apparatus to reduce the resource burden on the UE while maintaining efficient mobility management are desirable.

Various aspects relate generally to wireless communication and, more particularly, to layer 1/layer 2 (L1/L2) mobility, which may also be referred to interchangeably as LTM. Some aspects more specifically relate to partial transmission configuration indication (TCI) activation for L1/L2 based fast mobility. In some examples, a UE may monitor a first cell through one or more active TCI states of the first cell. The first cell may be a serving cell of the UE. The UE may further monitor a reference signal associated with one or more partially active TCI states of a second cell for LTM, where the second cell is a non-serving cell of the UE, and perform the LTM handover to change the serving cell from the first cell to the second cell in response to an LTM command indicating an LTM handover and based on at least one of the partially active TCI states and the active TCI states. In some examples, prior to being configured to monitor the reference signal of the second cell, the UE may deactivate at least one active TCI state of the one or more active TCI states of the first cell in response to the number of active TCI states of the first cell reaching the full-state threshold.

Particular aspects of the subject matter described in this disclosure can be implemented to realize one or more of the following potential advantages. In some examples, by monitoring a reference signal associated with one or more partially active TCI states of a second cell for LTM, the described techniques can be used to enable the UE to use a partially active TCI state to monitor candidate cells for LTM, which substantially reduces the LTM handover (HO) delay and interruption length during an LTM HO. Hence, it improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well-known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

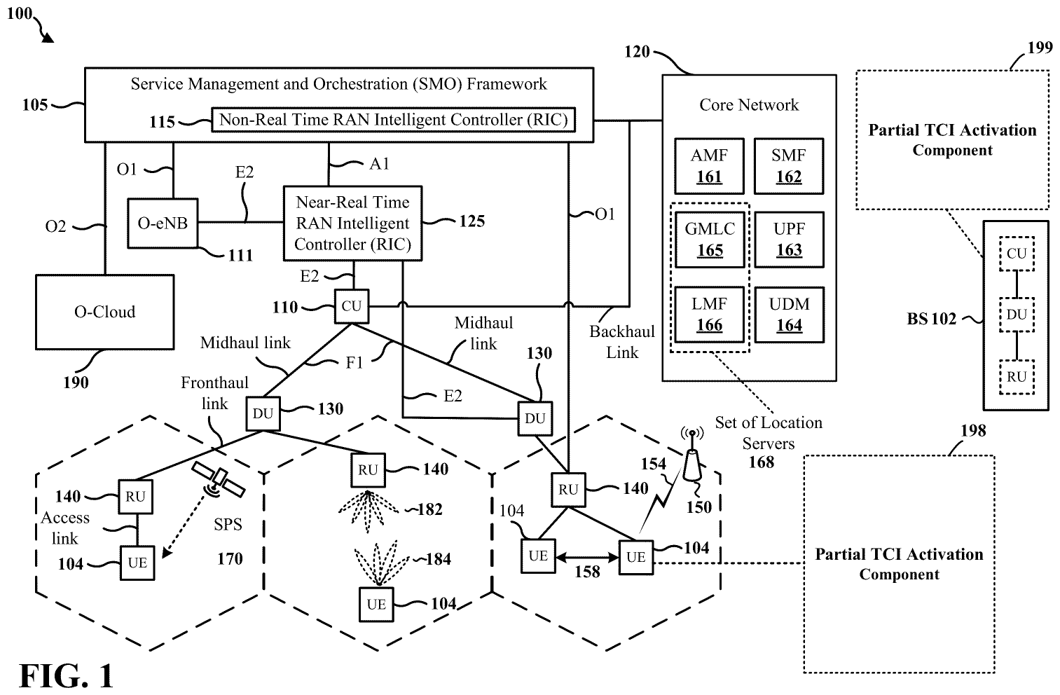

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a partial TCI activation component 198. The partial TCI activation component 198 may be configured to monitor a first cell through one or more active TCI states of the first cell, where the first cell is a serving cell of the UE; monitor a reference signal associated with one or more partially active TCI states of a second cell for LTM, where the second cell is a non-serving cell of the UE; and perform, in response to an LTM command indicating an LTM handover, and based on at least one of the partially active TCI states and the active TCI states, the LTM handover to change the serving cell from the first cell to the second cell. In certain aspects, the base station 102 may include a partial TCI activation component 199. The partial TCI activation component 199 may be configured to transmit, to a UE, one or more active TCI states. The UE may be configured to monitor a reference signal associated with one or more partially active TCI states of a second cell for LTM. The first cell may be a serving cell of the UE, and the second cell may be a non-serving cell of the UE. The partial TCI activation component 199 may be further configured to transmit, to the UE, an LTM command indicating an LTM handover to cause the UE to perform, in response to the LTM command, the LTM handover to change the serving cell from the first cell to the second cell based on at least one of the partially active TCI states and the active TCI states. Although the following description may be focused on 5G NR, the concepts described herein may be applicable to other similar areas, such as LTE, LTE-A, CDMA, GSM, and other wireless technologies.

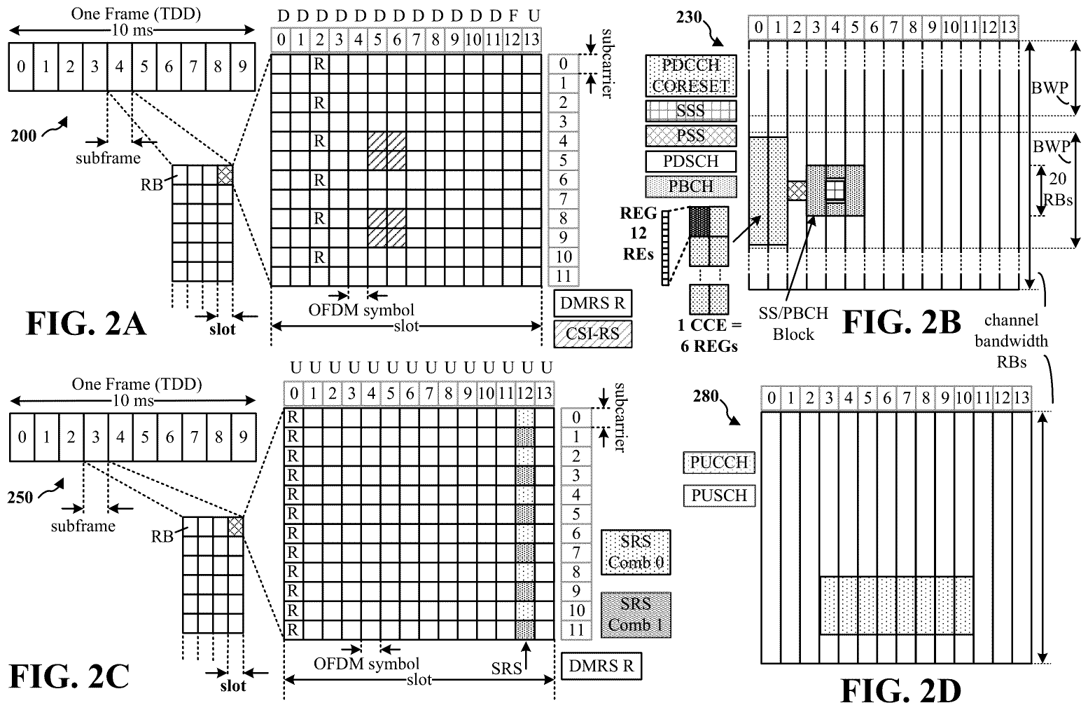

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

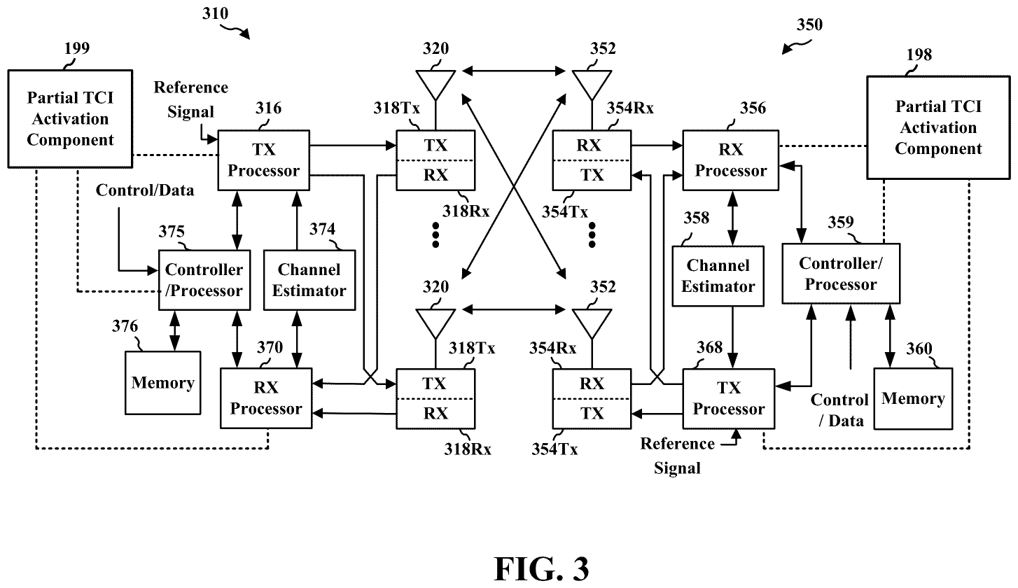

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the partial TCI activation component 198 of FIG. 1.

At least one of the TX processor 316, the RX processor 370, and the controller/processor 375 may be configured to perform aspects in connection with the partial TCI activation component 199 of FIG. 1.

A network may be in communication with a UE based on one or more beams (spatial filters). For example, a base station of the network may transmit a beamformed signal to a UE in one or more directions that correspond with one or more beams. The base station and the UE may perform beam training to determine the best receive and transmit beam directions for the base station and the UE.

In response to different conditions, beams may be switched. For example, a TCI state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. A TCI state may include quasi co-location (QCL) information that the UE can use to derive timing/frequency error and/or transmission/reception spatial filtering for transmitting/receiving a signal.

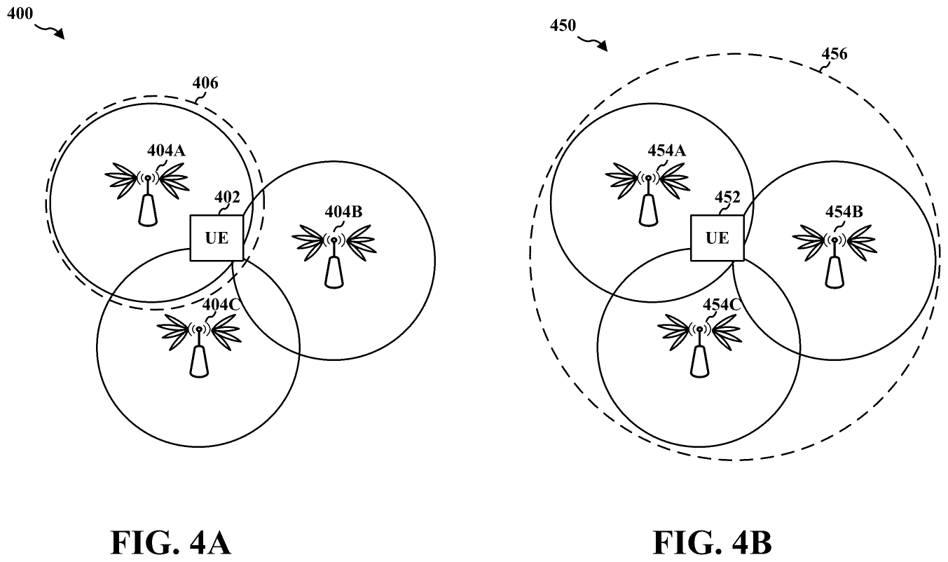

Different procedures for managing and controlling beams may be collectively referred to as “beam management.” The process of selecting a beam to switch to for data channels or control channels may be referred to as “beam selection.” In some wireless communication systems, beam selection for data channels or control channels may be limited to beams within the same physical cell identifier (ID) (PCI). A PCI may be associated with a TRP. FIG. 4A is a diagram 400 illustrating an example of beam management. As illustrated in FIG. 4A, for a UE 402, beam selection 406 may be limited to beams within the PCI 404A and beams associated with the PCI 404B and the PCI 404C may not be used. As an example, each of the PCI 404A, the PCI 404B, and the PCI 404C may be associated with a different TRP.

By way of example, a UE may encounter two types of mobility—cell-level mobility and beam-level mobility (which may be beam-based mobility). For cell-level mobility, a UE may experience an inter-base station handover. In some wireless communication systems, for beam-level mobility, as previously explained, switching of beams may occur within the same base station.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network. FIG. 4B is a diagram 450 illustrating an example of inter-cell beam management. As illustrated in FIG. 4B, for a UE 452, beam selection 456 may be based on beams within the PCI 454A and beams associated with the PCI 454B and the PCI 454C. As an example, each of the PCI 454A, the PCI 454B, and the PCI 454C may be associated with a different TRP.

As an example, inter-cell beam management based on beam-based mobility may be facilitated by L1 and/or L2 (L1/L2) signaling, such as UE-dedicated channels/RSs, which may be associated with a switch to a TRP with different PCI according to downlink control information (DCI) or medium access control (MAC) control element (MAC-CE) based unified TCI update. As used herein, such mobility may be referred to as L1/L2 mobility or LTM.

In some aspects, the network may configure a set of cells for L1/L2 mobility or LTM. The set of cells for L1/L2 mobility may be referred to as L1/L2 mobility configured cell set or an LTM configured cell set. A subset of the L1/L2 mobility configured cell set may be activated (e.g., with L1 or L2 control signaling) and may be referred to as an L1/L2 mobility activated cell set (which may also be referred to as an L1/L2 activated mobility cell set or LTM activated cell set). The subset of the L1/L2 mobility configured cell set that is not activated or that is indicated to be deactivated may be referred to as an L1/L2 mobility deactivated cell set or a deactivated L1/L2 mobility cell set or an LTM deactivated cell set. The L1/L2 mobility activated cell set may be a group of cells in the L1/L2 mobility configured cell set that are activated and may be readily used for data and control transfer. The L1/L2 mobility deactivated cell set (which may be an L1/L2 mobility candidate cell set) may be a group of cells in the configured set that is configured for the UE yet deactivated (e.g., not used for data/control transfer until activated) and may be activated by L1/L2 signaling. Once activated, a deactivated cell may be used for data and control transfer. The configuration and maintenance of multiple candidate cells may allow for a quicker application of configurations for the candidate cells, and the activated set of cells may provide for dynamic switching among the candidate serving cells (e.g., including a special cell (SpCell) and SCell) based on L1 or L2 signaling.

The procedures of L1/L2 based inter-cell mobility or LTM are applicable to many scenarios. These scenarios may include, but not limited to, standalone CA and NR-DC cases with serving cell changing within one CG, intra-DU cases and intra-CU inter-DU cases (applicable for standalone and CA, with no new RAN interface expected), intra-frequency and inter-frequency cases, FR1 and FR2 cases. In these scenarios, the source and target cells may be synchronized or non-synchronized.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by Radio Signal Received Power (RSRP), and quality represented by Radio Signal Received Quality (RSRQ), or other measurements that the UE performs on signals from the base station. In some aspects, the measurements may be L1 measurements, such as one or more of an RSRP, an RSRQ, a received signal strength indicator (RSSI), or a signal-to-noise and interference ratio (SINR) measurement of various signals, such as an SSB, a PSS, an SSS, a broadcast channel (BCH), a DM-RS, CSI-RS, or the like.

In some aspects, all cells in the L1/L2 mobility configured cell set may belong to the same DU and the cells may be on the same or different carrier frequencies. Cells in the L1/L2 mobility configured cell set may cover a mobility area.

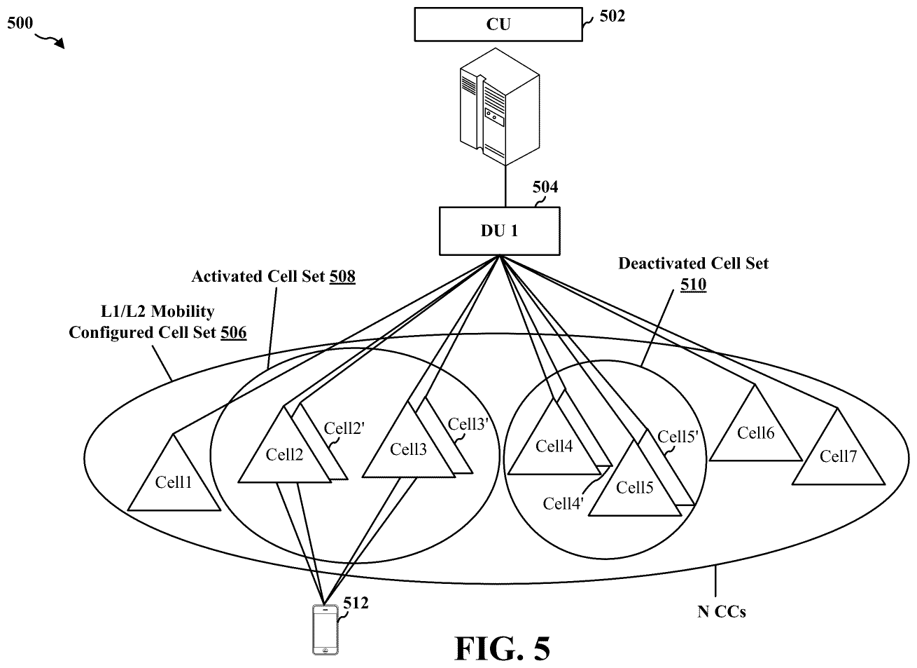

FIG. 5 is a diagram 500 illustrating an example of cell configuration. As illustrated in FIG. 5, a CU 502 (which may correspond to a component of a base station such as a gNB) may be associated with a first DU 504 (and other DUs). An L1/L2 mobility configured cell set 506 may be associated with the first DU 504 and may include an L1/L2 mobility activated cell set 508 and an L1/L2 mobility deactivated cell set 510. The L1/L2 mobility configured cell set 506 may also include one or more cells not in the current L1/L2 mobility activated cell set 508 or the current L1/L2 mobility deactivated cell set 510. For example, at a given time, the L1/L2 mobility activated cell set 508 may include a first subset of the L1/L2 mobility configured cell set, and the L1/L2 mobility deactivated cell set 510 may include a second, non-overlapping subset of the L1/L2 mobility configured cell set. There may remain one or more cells that are in the L1/L2 mobility configured cell set that are not in the first set subset (e.g., activated) or the second subset (e.g., deactivated). A UE 512 may use the cells in the L1/L2 mobility activated cell set 508 for data channel and control channel communications.

A UE may be provided with a subset of L1/L2 mobility deactivated cells (candidate cell set) that the UE may autonomously choose to add to the L1/L2 mobility activated cell set. For example, the UE may add cells in the subset of L1/L2 mobility deactivated cells to the L1/L2 mobility activated cell set based on measurements (e.g., measured channel quality), loading, or the like. In some aspects, each of the RUs could have multi-component carrier (CC) (N CCs) support (where each CC is a cell). In some aspects, activation or deactivation may be performed for groups of carriers (cells). For PCell management, L1/L2 signaling may be used to set the PCell out of the configured options within the activated cell set. In some aspects, L3 mobility may be used for PCell change (L3 handover) when a new PCell is not from the activated cell set for L1/L2 mobility. As an example, RRC signaling may be used to update the set of cells for L1/L2 mobility at L3 handover. In some aspects, L1/L2 mobility configured cells may be associated with a PCell configuration without being the PCell. The PCell configuration may be activated and one of the L1/L2 mobility activated cells (e.g., in an L1/L2 mobility activated cell set) may be activated based on L1/L2 signaling to become a PCell. In some aspects, L1/L2 mobility deactivated cells (e.g., in an L1/L2 mobility deactivated cell set) may support L1 measurements to facilitate sufficient beam management, timing synchronization, power control, or the like. For L1/L2 mobility deactivated cells, measurement reporting may be done on an activated cell.

A network node (e.g., a base station) may change a SpCell for a UE using a layer 3 (L3) handover (e.g., using radio resource control (RRC) signaling). However, L3 handovers may be time-consuming and/or inefficient. A network node that utilizes the improved L1/L2 signaling scheme is able to change one or more cells for a UE in a more rapid manner in comparison to L3 (RRC) based approaches. In an example, a UE receives an L1 or L2 mobility cell configuration for a set of cells for L1 or L2 inter-cell mobility. The set of cells may include multiple cells, and each cell in the set of cells is able to be activated or deactivated for data and/or control transfer using L1 or L2 signaling. The UE receives L1 or L2 signaling indicating multiple activated cells, and activates one or more cells in the multiple activated cells in a priority order for the data and/or control transfer using L1 or L2 signaling. Via the aforementioned L1 or L2 signaling, one or more cells, including SpCell and SCell, are able to be activated and/or deactivated in a manner that avoids RRC-based signaling. As a result, the cells may be activated and/or deactivated in a more rapid manner in comparison to RRC-based signaling. Additionally, the cells may be activated in a priority order to further facilitate more efficient and robust mobility management.

A base station may configure a UE, e.g., in RRC signaling, with a set of cells for L1/L2 mobility. The set of cells may be referred to as an L1/L2 mobility configured set. A subset of the cells in the configured set may be activated and can be used for data and control transfer between the UE and the network. The subset of activated cells may be referred to as the L1/L2 mobility activated cell set. A subset of the L1/L2 mobility configured set may be deactivated and may be referred to as the L1/L2 mobility deactivated set. The L1/L2 deactivated set of cells can be activated for the UE by L1/L2 signaling from the network.

In conditional handover, a set of candidate cells (including cell ID, system information, etc.) and conditions for handover may be configured in advance via RRC. When the configured condition is met for one of the configured candidate cells, the UE may initiate the handover procedure by transmitting PRACH toward the candidate cell. The handover completion may be notified to the previous serving cell by the new serving cell. DL/UL channel between the UE and the new cell might not be immediately usable for high speed/volume traffic due to the lack of, for example, channel state information between the UE and the new cell.

For enhanced mobility, the UE may be configured with a set of candidate cells (including cell ID, system information, etc.) in advance, and the UE may be expected to keep performing L1 and L3 measurements for the configured candidate cells. A handover toward a specific cell among the preconfigured candidate cells will be initiated via L1 and/or L2 messages. The handover allows the DL/UL channel over the new link to be immediately usable for high speed/volume traffic as soon as the handover procedure is completed. As a part of the fast handover procedure, communication is improved with a seamless UL power control mechanism. Otherwise, DL/UL transmission/reception may be delayed except for PRACH and Random Access Response (RAR) for UL power control initialization, even when Timing Advance (TA) for the new cell is obtained by other means.

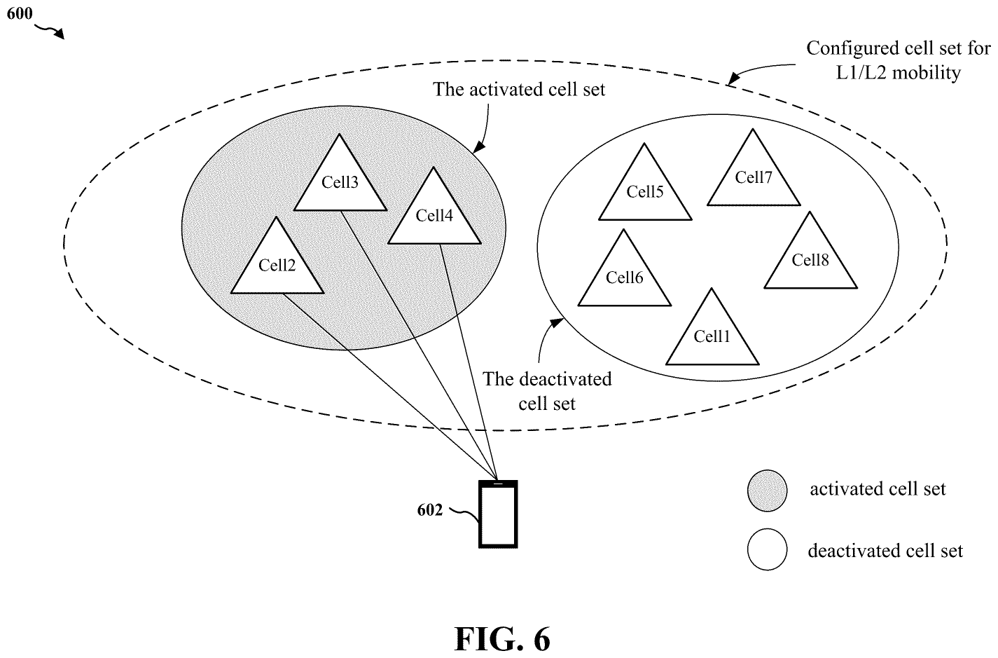

FIG. 6 is a diagram 600 illustrating a system model of an example cell configuration. As shown in FIG. 6, a UE 602 may be configured with a set of cells (Cell1, . . . , Cell8) for L1/L2 mobility. The set of cells may be configured through radio resource control (RRC) signaling. The set of cells may be on the same frequencies, and the existing mechanism of carrier aggregation (CA) may be utilized to enable L1/L2 mobility. Cells in the configured set may be further characterized into two groups: activated cells and deactivated cells. The activated cells are serving cells that are currently active and can be used for data and control transfer. The deactivated cells are serving cells that are currently deactivated (and hence have no active data or control communication with the UE 602) but can be quickly activated through L1/L2 signaling to the UE from the network.

The UE 602 may be a mobile device and may be moving while communicating with the cells in the configured cell set. L1/L2 signaling may be used to activate/deactivate cells in the set and to select beams within the activated cells. For example, as the UE 602 moves, the serving cell may change based on, for example, the UE's location and measurement reports using L1/L2 singling. A group of cells may be activated at one time. L1/L2 signaling may be used to set the PCell out of the configured PCell options within the activated cell set. L3 mobility may be used for PCell change (L3 handover) to a new PCell is not from the configured cell set for L1/L2 mobility, and RRC signaling may update the set of cells for L1/L2 mobility at L3 handover.

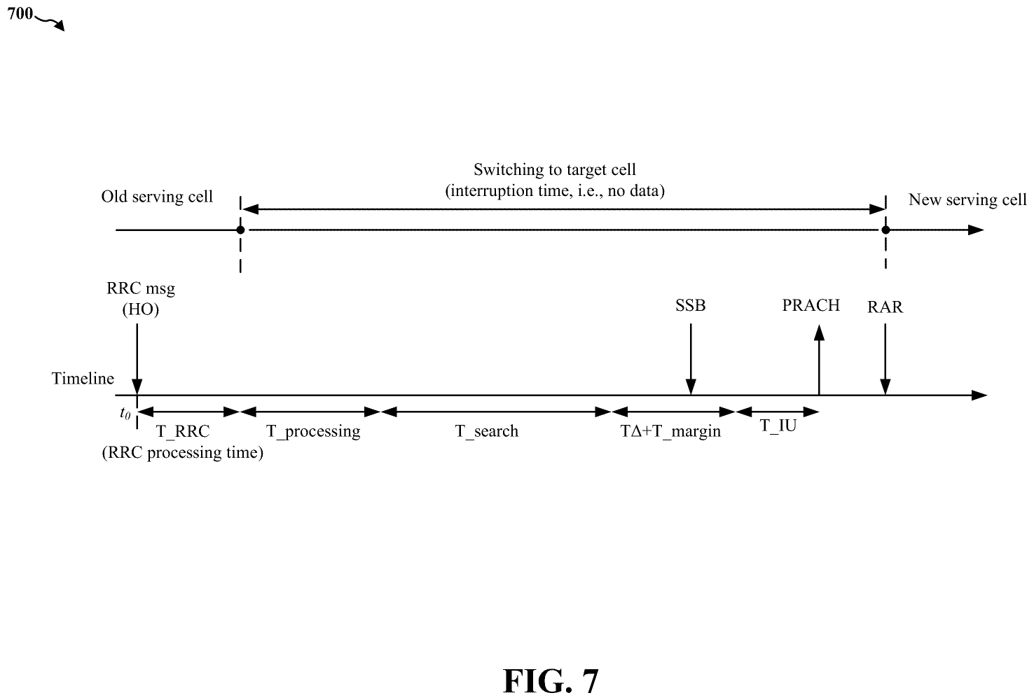

FIG. 7 is a diagram 700 illustrating an L3-based handover delay. As shown in FIG. 7, in an L3-based handover, after a UE receives a HO command at to, the time the UE may take until a connection to the new serving cell is established may include T_RRC, T_processing, T_search, TΔ, T_margin, and T_IU. T_RRC is the RRC processing time, and T_processing is the time for the UE processing, which may be up to 20 milliseconds (ms). T_search is the time the UE takes to search the target cell if the target cell is not already known at the time the HO command is received by the UE. TΔ is the time for fine time tracking and acquiring full timing information of the target cell, and may be the SSB-based measurement timing configuration (SMTC) periodicity of the target cell. T_margin is the time for SSB post-processing, which may be up to 2 ms. T_IU is the interruption uncertainty in acquiring the first available PRACH occasion in the new cell. T_IU may be up to the summation of SSB to PRACH occasion association period and 10 ms. As shown in FIG. 7, when switching the target cell, there is an interruption time after T_RRC and before the connection to the new serving cell is established, during which no data is transmitted.

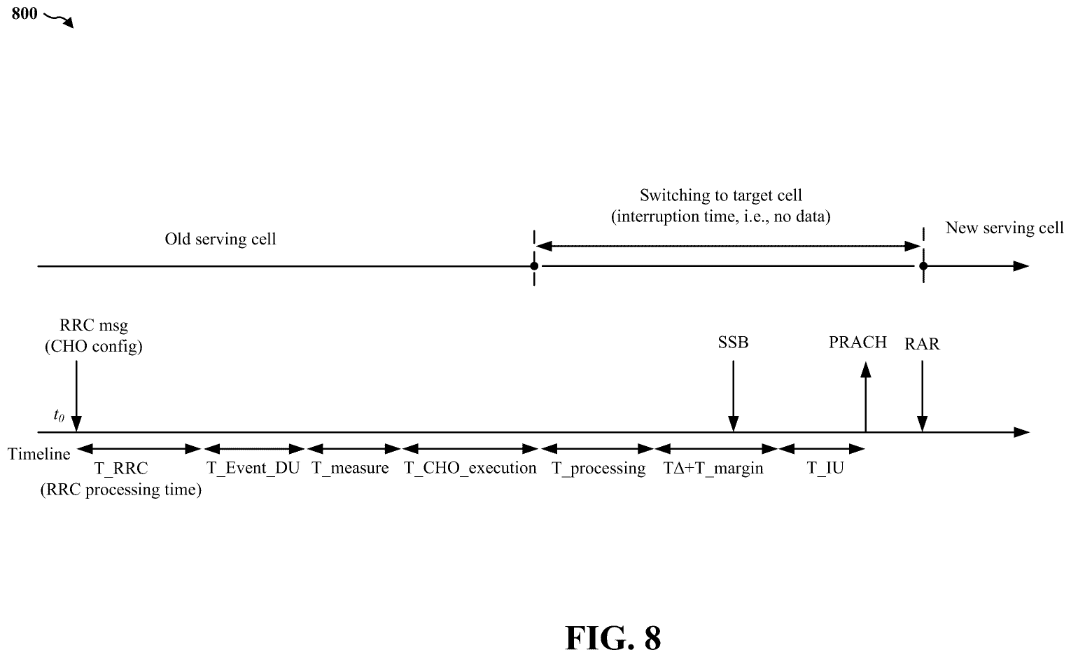

FIG. 8 is a diagram 800 illustrating an L3-based conditional handover delay. As shown in FIG. 8, in an L3-based conditional handover (CHO), after a UE receives a CHO configuration at to, the time the UE may take until a connection to the new serving cell is established may include T_RRC, T_Event_DU, T_measure, T_CHO_execution, T_processing, T_search, TA, T_margin, and T_IU. T_RRC is the RRC processing time. T_Event_DU is the delay uncertainty, which is the time from the UE successfully decoding a CHO command until a condition exists at the measurement reference point, which will trigger the conditional handover. T_measure is the measurement time. T_CHO_execution is the UE execution preparation time for CHO, which may start after the UE realizes the condition of CHO is met and the identity of the target cell is determined. T CHO_execution may be up to 10 ms. T_processing is the time for UE processing, which may be up to 20 ms). TA is the time for fine time tracking and acquiring full timing information of the target cell. TA may be the SMTC periodicity of the target cell. T_margin is the time for SSB post-processing (which may be up to 2 ms). T_IU is the interruption uncertainty in acquiring the first available PRACH occasion in the new cell. T_IU may be up to the summation of SSB to PRACH occasion association period and 10 ms. As shown in FIG. 8, when switching the target cell using CHO, there is an interruption time after T_CHO_execution and before the connection to the new serving cell is established, during which no data is transmitted.

The measurement and the mobility may be intra-frequency or inter-frequency. For SSB-based L1 measurement, intra-frequency or inter-frequency may be based on the center frequency and SCS of serving cell SSB but not BWP. For SSB L1-RSRP measurement, if the center frequency and SCS of the SSB of the neighbor cell is the same as the SSB of the serving cell indicated in the parameter ServingCellConfigCommon, the measurement may be an SSB-based intra-frequency L1 measurement. The supported scenarios not included in intra-frequency L1 measurement may be regarded as inter-frequency L1 measurement.

In an L3-based HO, resources are used for a UE to keep track of synchronization reference signal(s) for fine time/frequency tracking from a candidate cell in preparation for LTM, which may be SSB or CSI-RS configured for tracking. For example, from a UE implementation perspective, continuing SSB monitoring for the fine time/frequency tracking with one SSB may require similar, if not more, resources for using one TCI state (irrespective of whether the SSB belongs to a serving or a non-serving cell).

The present disclosure provides methods and apparatus for partial TCI activation for L1/L2 based fast mobility, which is also referred to herein as LTM. In one example, for a UE supporting up to two active TCI states, at any given time, the number of reference resources (e.g., SSB or CSI-RS) that the UE is to monitor for L1 measurements from cells may not be larger than a threshold number N. The number N is based on a UE capability and may be limited by the maximum number of active TCI states supported by the UE, e.g., as a UE capability. If the UE is expected to be signaled to perform a HO based on LTM (which would not allow as much delay as an L3 HO), the network may first ensure that the number of activated TCI states with the serving cell plus the number of SSBs to be monitored for fine time/frequency tracking from the target cell will not exceed N. Then, the network can reconfigure the UE's activated TCI states, or deactivate one of the active TCI states and partially activate a new TCI state associated with the target cell. The new partially activated TCI state associated with the target cell may be referred to as a “partially active TCI state.” The partially active TCI state may be used for the synchronization monitoring of, for example, one SSB from a non-serving cell. In the LTM context, for a partially active TCI state from a non-serving cell (candidate cell or target cell), the UE may not monitor the PDCCH associated with the partially active TCI state.

In some aspects, for a UE supporting the UE capability of the total number of active TCI states up to N (e.g., based on parameters such as tci-StatePDSCH, maxNumberActivatedTCI-States-r16, simultaneousTCI-ActMultipleCC-r16, mTRP-inter-Cell-r17, unifiedJointTCI-InterCell-r17, maxConfiguredJointTCI-r17, maxActivatedTCIAcrossCC-r17), the UE may advertise, or inform the network, of the following UE capabilities for LTM.

In some aspects, the UE capabilities for LTM may include an exchange rate between an active TCI state from a serving cell and a partially active TCI state from a non-serving cell for LTE can be 1 to P. The UE may indicate to the network that it supports a particular exchange rate between active TCI states and partially active TCI states. For example, the rate may be based on one TCI state to be activated for a serving cell being exchanged with P partially active TCI states for LTM. The P partially active TCI states may be for synchronized monitoring of P SSBs from non-serving candidate cell(s). In one example, the maximum total number of TCI states at a given time across cells (including serving cells and candidate cells) may be: 1+(N−1)×P.

In some aspects, the UE capabilities for LTM may further include the UE capability of using the total number (T) of partially active TCI states for LTM purposes. The UE may indicate to the network the total number of partially active TCI states that the UE supports for LTM. In some examples, the total number T may not include SSBs from serving candidate cells (e.g., in cell swapping between SpCell and SCell in CA/DC mode). In some examples, the total number T may be the number of total TCI states, including active TCI states from the serving cell. In these examples, the total number T may be the total number of active TCI states plus the new total number of partially active TCI states to be used for LTM purposes.

In some aspects, the total number T may be CC-specific. For example, each CC may have its own total number T, e.g., and the UE may indicate a value T that it supports for each of multiple CCs. In some aspects, the total number T may be across CCs. For example, one total number T may apply across multiple CCs or may apply to all the CCs. In some aspects, the total number T that the UE supports for intra-frequency LTM may be different than the total number T that the UE supports for inter-frequency LTM. In other examples, the UE may support the same number T for intra-frequency and inter-frequency LTM.

In some aspects, a TCI for LTM with a candidate/target cell may be (partially) activated at least a time gap before the LTM HO command. The time gap may be a certain number of slots (e.g., S slots). For example, the UE may start monitoring a reference signal associated with a partially active TCI state from a candidate/target cell at least S slots before the LTM HO command. By monitoring the reference signal associated with the partially active TCI state at least S slots before the LTM HO command, the UE has at least one opportunity to measure the reference signal (e.g., SSB or CSI-RS) associated with the target cell. That allows the UE to perform a pre-synchronize procedure with the target cell and reduces the latency of the LTM HO. When at least one configured/associated reference signal from the target cell, such as the SSB associated with the partially active TCI, is present within the S slots, the LTM HO delay (e.g., the time from the LTM HO signal reception to the first UL transmission to the target cell or the first PDCCH/PDSCH reception from the target cell) and the interruption due to LTM HO may be substantially reduced. The number of slots (e.g., S) before the LTM HO command may be different depending on the frequency range (FR) (and is based on the target cell or the serving cell) and whether the reference signal (e.g., SSB) had been previously measured by the UE within a certain period of time before the partial TCI activation.

In some aspects, signals/channels that are received by the UE during and immediately after the LTM HO may be associated with the partially active TCI. For example, if a tracking reference signal (TRS) is transmitted from the target cell to shorten the LTM HO delay, the TRS may be associated with the partially active TCI. PDCCH and PDSCH to be received by the UE from the target cell may also be associated with the partially active TCI.

In some aspects, the partially active TCI states with a candidate cell/target cell may not be a prerequisite for LTM. If a UE has been monitoring a reference signal associated with a partially active TCI state for the target cell before the UE received the LTM HO command, the LTM HO delay may be reduced due to the fine time/frequency synchronization with the target cell. On the other hand, if the UE did not monitor the reference signal associated with a partially active TCI state of the target cell before the LTM HO command, the LTM HO may still be performed, although the latency may be longer.

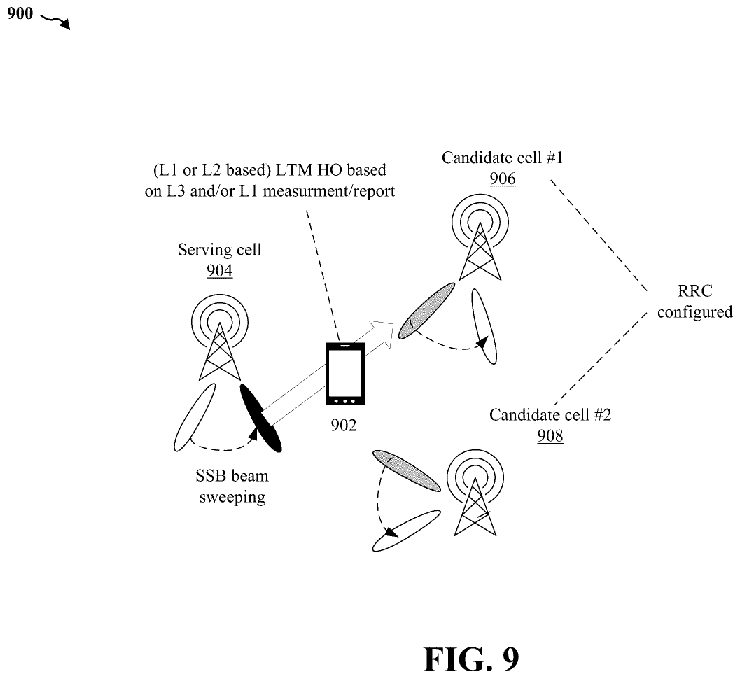

FIG. 9 is a diagram 900 illustrating an example of intra-frequency LTM HO, in accordance with various aspects of the present disclosure. In the example of FIG. 9, the UE 902 was originally connected to a serving cell 904, and there are two candidate cells (candidate cell #1 906 and candidate cell #2 908) available for potential LTM HO. Upon receiving an LTM HO command, the UE 902 may switch its serving cell from the original serving cell 904 to one of the candidate cells (e.g., to candidate cell #1 906).

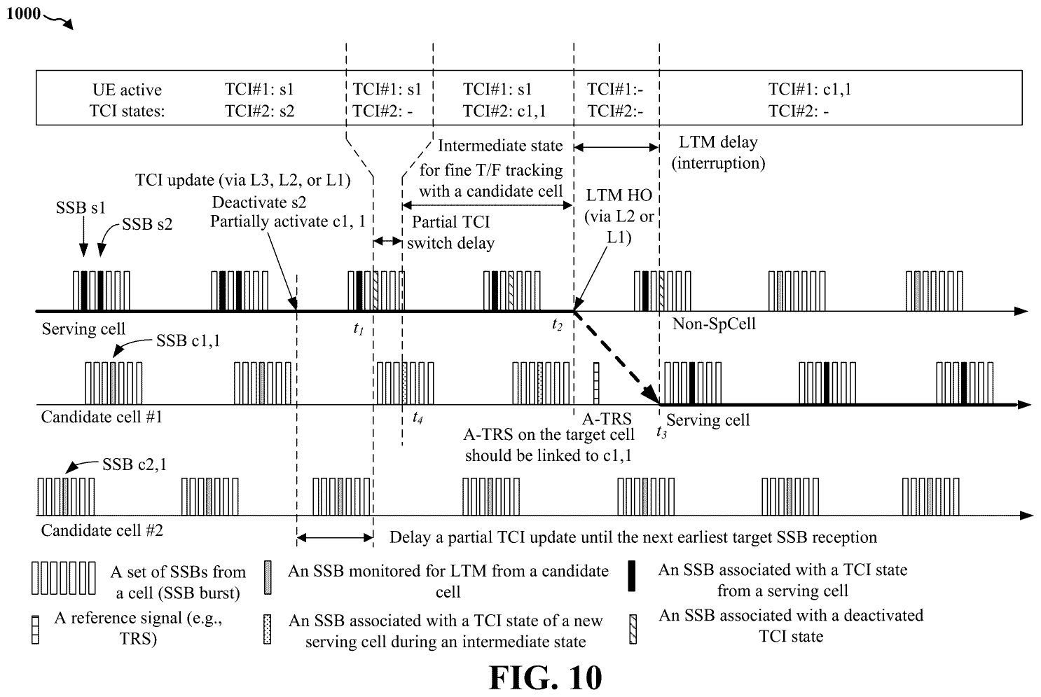

FIG. 10 is a diagram 1000 illustrating the TCI states during the example of intra-frequency LTM HO of FIG. 9. In the example of FIG. 9, the UE 902 may support two active TCI states. For example, as shown in FIG. 10, the UE 902 may monitor the SSB s1 and SSB s2 of the serving cell 904. To prepare for the LTM HO, the UE 902 may update the TCI (via L1, L2, or L3). The TCI update may include deactivating one of the active states (for example, SSB s2) of the serving cell 904 and partially activating a TCI state of a candidate cell. The partially activated TCI state of the candidate cell may be referred to as a partially active TCI state of the candidate cell. For example, the UE 902 may partially activate the TCI state SSB c1,1 (i.e., a partially active TCI state SSB c1,1) for candidate cell #1 906. The TCI update may be delayed until the next earliest target SSB reception for switching/processing if the update is to a candidate cell for LTM. For example, the PDCCH monitoring associated with the previously activated TCI state from the serving cell may be delayed to the greatest extent possible (e.g., until the UE 902 should start the TCI switch to receive the reference signal associated with the to-be-partially-activated TCI state). As shown in FIG. 10, after t₁, the active TCI state SSB s2 associated with the serving cell 904 will be deactivated, and the partially active TCI state SSB c1,1 associated with the candidate cell #1 906 will be activated. During an intermediate state after the TCI update and before the LTM HO is completed, the UE 902 may monitor an active TCI state SSB s1 associated with the serving cell 904 and a partially active TCI state SSB c1,1 associated with candidate cell #1 906. The UE 902 may perform LTM HO to switch the serving cell from the serving cell 904 to the candidate cell #1 906 based on the active TCI state SSB s1 and the partially active TCI state SSB c1,1. If a Tracking Reference Signal (TRS), such as an aperiodic TRS (A-TRS) is triggered on the target cell (e.g., the candidate cell 906) during the LTM HO (e.g., from time t₂ to t₃) or immediately after the LTM HO, the TRS may be associated with the partially active TCI (e.g., SSB c1,1). PDCCH and PDSCH to be received by the UE 902 from the target cell (e.g., the candidate cell #1 906) may also be associated with the partially active TCI (e.g., SSB c1,1). After the LTM HO is completed, the candidate cell #1 906 becomes the new serving cell (e.g., starting from t₃), and the original serving cell 904 becomes a non-SpCell.

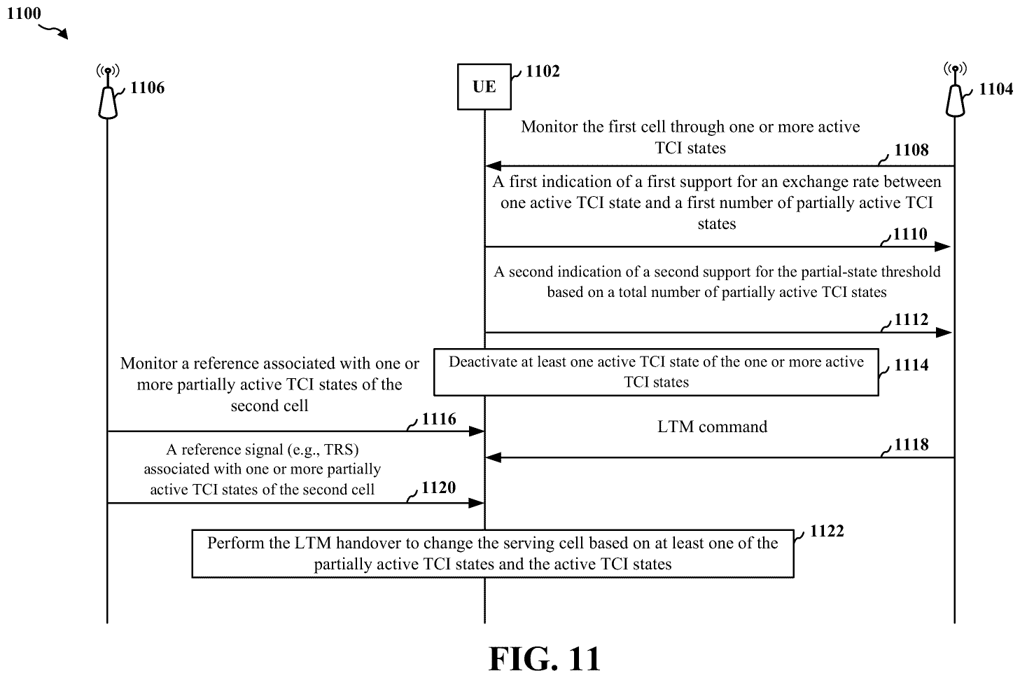

FIG. 11 is a call flow diagram 1100 illustrating a method of wireless communication in accordance with various aspects of this present disclosure. Although aspects are described for a first cell 1104 (e.g., a base station), the aspects may be performed by a base station in aggregation and/or by one or more components of a first cell 1104 (e.g., such as a CU 110, a DU 130, and/or an RU 140).

As shown in FIG. 11, a UE 1102 may monitor, at 1108, a first cell 1104 through one or more active TCI states of the first cell 1104. The first cell 1104 may be a serving cell of the UE 1102. For example, referring to FIGS. 9 and 10, the first cell 1104 may be the serving cell 904, and the UE 902 may monitor the first cell (serving cell 904) through one or more active TCI states (e.g., SSB s1 and SSB s2 in FIG. 10).

At 1110, the UE 1102 may transmit a first indication of a first support for an exchange rate between one active TCI state and a first number of partially active TCI states to the first cell 1104. For example, referring to FIGS. 9 and 10, the UE 902 may transmit a first indication of a first support for an exchange rate between one active TCI state (e.g., SSB s1 and SSB s2 in FIG. 10) and a first number of partially active TCI states (SSB c1,1 and SSB c2,1 in FIG. 10) to the first cell (serving cell 904).

At 1112, the UE 1102 may transmit a second indication of a second support for the partial-state threshold based on the total number of partially active TCI states supported by the UE 1102. For example, referring to FIGS. 9 and 10, the UE 902 may transmit a second indication of a second support for the partial-state threshold based on the total number of partially active TCI states (e.g., SSB c1,1 and SSB c2,1 in FIG. 10) supported by the UE 902.

At 1114, the UE 1102 may deactivate at least one active TCI state of the one or more active TCI states. For example, referring to FIGS. 9 and 10, the UE 902 may deactivate at least one active TCI state (e.g., SSB s2 in FIG. 10) of the one or more active TCI states.

At 1116, the UE 1102 may monitor a reference signal associated with one or more partially active TCI states of the second cell 1106 for LTM. The second cell may be a non-serving cell of the UE 1102. For example, referring to FIGS. 9 and 10, the UE 902 may monitor a reference signal associated with one or more partially active TCI states (e.g., SSB c1,1 in FIG. 10) of the second cell (e.g., candidate cell #1 906) for LTM. The candidate cell #1 906 may be a non-serving cell of the UE 902.

At 1118, the UE 1102 may receive an LTM command from the first cell 1104. For example, referring to FIGS. 9 and 10, UE 902 may receive an LTM command (at t₂) from the first cell (serving cell 904).

At 1120, the UE 1102 may receive a reference signal from the second cell 1106. The reference signal may be associated with one or more partially active TCI states of the second cell 1106. For example, referring to FIGS. 9 and 10, the UE 902 may receive a reference signal (e.g., TRS) from the second cell (candidate cell #1 906). The reference signal may be associated with one or more partially active TCI states (e.g., SSB c1,1 in FIG. 10) of the second cell (candidate cell #1 906).

At 1122, the UE 1102 may perform the LTM handover to change the serving cell from the first cell 1104 to the second cell 1106 in response to an LTM command indicating an LTM handover and based on at least one of the partially active TCI states and the active TCI states. For example, referring to FIGS. 9 and 10, the UE 902 may perform the LTM handover (e.g., LTM HO during t2 to t3 in FIG. 10) to change the serving cell from the first cell (serving cell 904) to the second cell (candidate cell #1 906) in response to an LTM command indicating an LTM handover and based on at least one of the partially active TCI states (e.g., SSB c1,1) and the active TCI states (e.g., SSB s1).

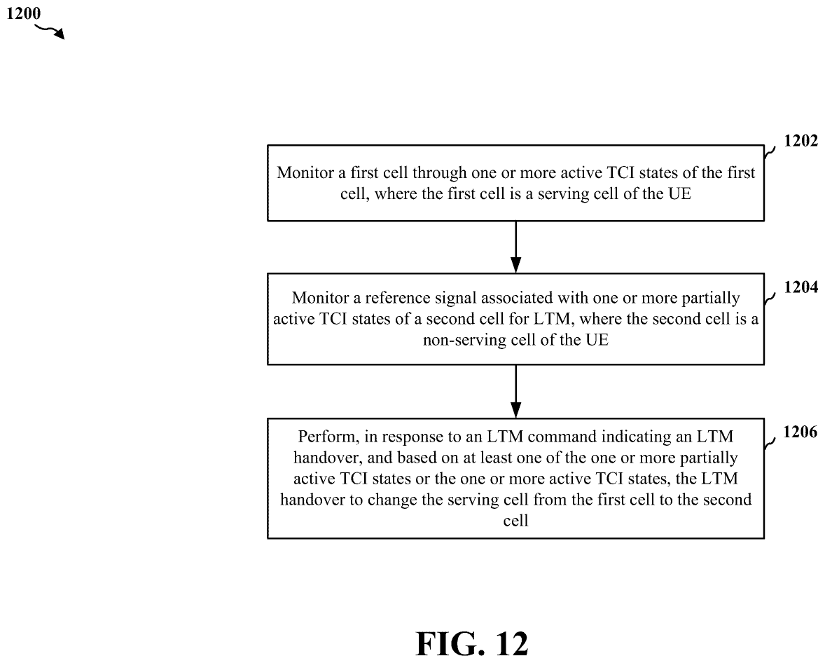

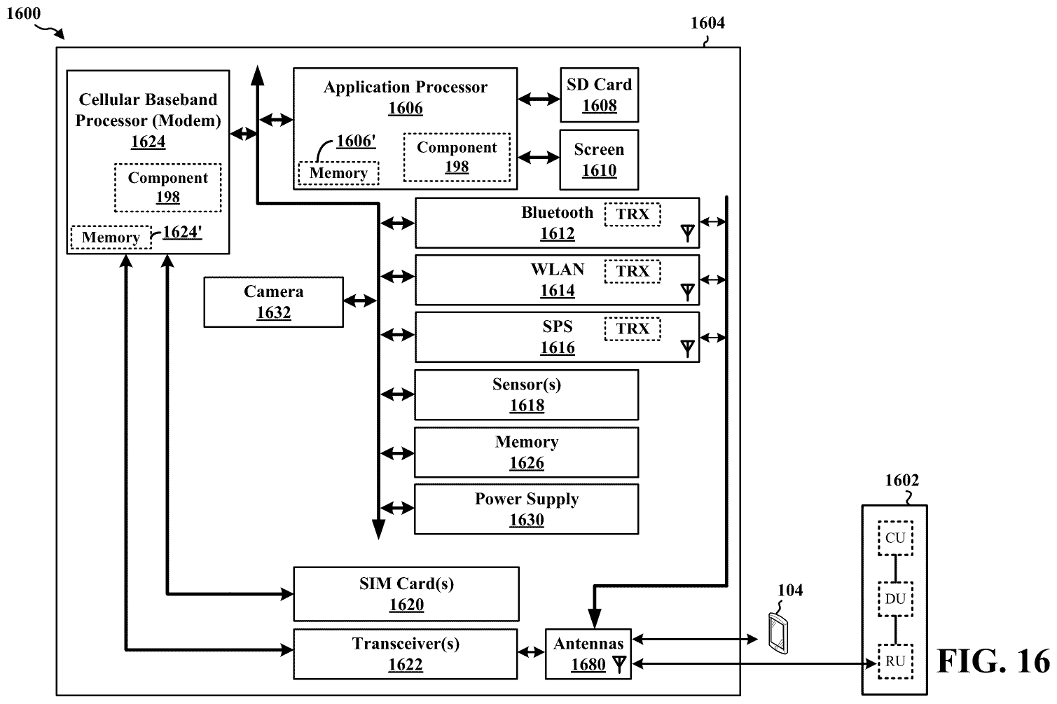

FIG. 12 is a flowchart 1200 illustrating methods of wireless communication at a UE in accordance with various aspects of the present disclosure. The method may be performed by a UE. The UE may be the UE 104, 350, 902, 1102, or the apparatus 1604 in the hardware implementation of FIG. 16. The method enables a UE to use a partially active TCI state to monitor a reference signal from candidate cells for LTM. It substantially reduces the LTM HO delay and interruption length during an LTM HO. Hence, it improves the efficiency of wireless communication.

As shown in FIG. 12, at 1202, the UE may monitor a first cell through one or more active TCI states of the first cell. The first cell may be a serving cell of the UE. The first cell may be a base station, or a component of a base station, in the access network of FIG. 1 or a core network component (e.g., base station 102, 310; serving cell 904; first cell 1104; or the network entity 1602 in the hardware implementation of FIG. 16). FIGS. 9, 10, and 11 illustrate various aspects of the steps in connection with flowchart 1200. For example, referring to FIG. 11, the UE 1102 may monitor, at 1108, a first cell 1104 through one or more active TCI states of the first cell 1104. The first cell may be a serving cell of the UE. Referring to FIGS. 9 and 10, the UE 902 may monitor a first cell (serving cell 904) through one or more active TCI states (SSB s1, SSB s2) of the first cell (serving cell 904). In some aspects, 1202 may be performed by the partial TCI activation component 198.

At 1204, the UE may monitor a reference signal associated with one or more partially active TCI states of a second cell for LTM. The second cell may be a non-serving cell of the UE for LTM. For example, the second cell may be candidate cell #1 906 or candidate #2 908 in FIG. 9. For example, referring to FIG. 11, the UE 1102 may monitor, at 1116, a reference signal associated with one or more partially active TCI states of a second cell 1106 for LTM. The second cell 1106 is a non-serving cell of the UE 1102. Referring to FIGS. 9 and 10, the UE 902 may monitor a reference signal associated with one or more partially active TCI states (e.g., SSB c1,1 in FIG. 10) of a second cell (candidate cell #1 906) for LTM. The second cell (candidate cell #1 906) is a non-serving cell of the UE 902. In some aspects, 1204 may be performed by the partial TCI activation component 198.

At 1206, the UE may perform the LTM handover to change the serving cell from the first cell to the second cell in response to an LTM command indicating an LTM handover and based on at least one of the partially active TCI states and the active TCI states. For example, referring to FIG. 11, the UE 1102 may perform, at 1122, the LTM handover to change the serving cell from the first cell 1104 to the second cell 1106 in response to an LTM command indicating an LTM handover and based on at least one of the partially active TCI states and the active TCI states. Referring to FIGS. 9 and 10, the UE 902 may perform the LTM handover to change the serving cell from the first cell (serving cell 904) to the second cell (candidate cell #1 906) in response to an LTM command indicating an LTM handover and based on at least one of the partially active TCI states (e.g., SSB c1,1 in FIG. 10) and the active TCI states (e.g., SSB s1 in FIG. 10). In some aspects, 1206 may be performed by the partial TCI activation component 198.

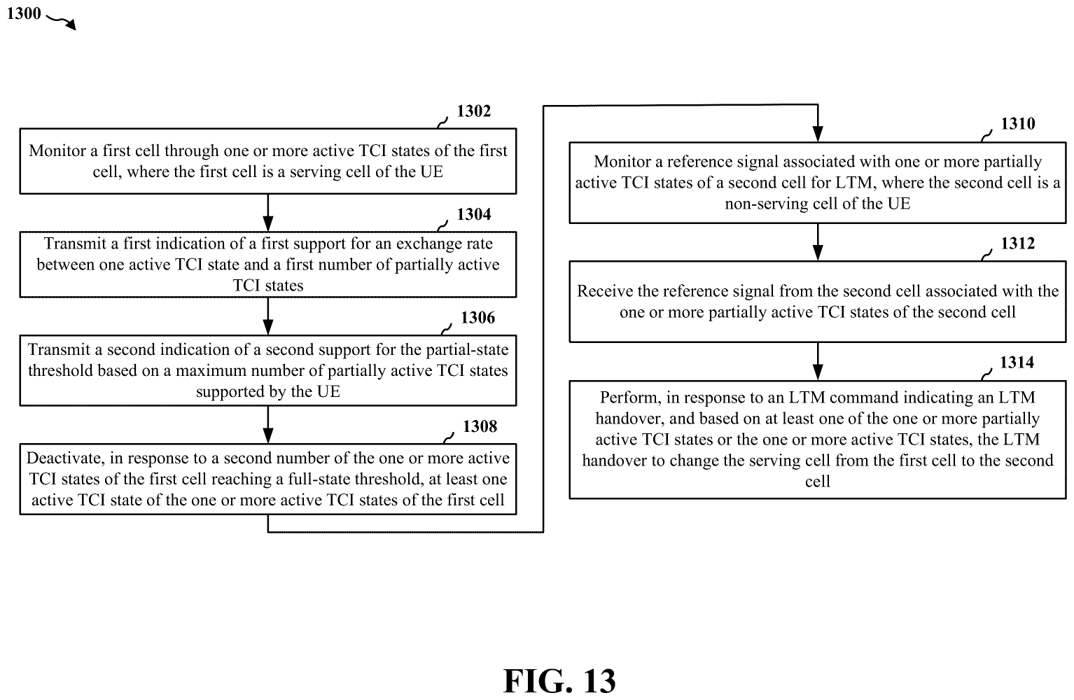

FIG. 13 is a flowchart 1300 illustrating methods of wireless communication at a UE in accordance with various aspects of the present disclosure. The method may be performed by a UE. The UE may be the UE 104, 350, 902, 1102, or the apparatus 1604 in the hardware implementation of FIG. 16. The method enables a UE to use a partially active TCI state to monitor a reference signal from candidate cells for LTM. It substantially reduces the LTM HO delay and interruption length during an LTM HO. Hence, it improves the efficiency of wireless communication.

As shown in FIG. 13, at 1302, the UE may monitor a first cell through one or more active TCI states of the first cell. The first cell may be a serving cell of the UE. The first cell may be a base station, or a component of a base station, in the access network of FIG. 1 or a core network component (e.g., base station 102, 310; serving cell 904; first cell 1104; or the network entity 1602 in the hardware implementation of FIG. 16). FIGS. 9, 10, and 11 illustrate various aspects of the steps in connection with flowchart 1300. For example, referring to FIG. 11, the UE 1102 may monitor, at 1108, a first cell 1104 through one or more active TCI states of the first cell 1104. The first cell may be a serving cell of the UE. Referring to FIGS. 9 and 10, the UE 902 may monitor a first cell (serving cell 904) through one or more active TCI states (SSB s1, SSB s2) of the first cell (serving cell 904). In some aspects, 1302 may be performed by the partial TCI activation component 198.

At 1310, the UE may monitor a reference signal associated with one or more partially active TCI states of a second cell for LTM. The second cell may be a non-serving cell of the UE for LTM. For example, the second cell may be candidate cell #1 906 or candidate #2 908 in FIG. 9. For example, referring to FIG. 11, the UE 1102 may monitor, at 1116, a reference signal associated with one or more partially active TCI states of a second cell 1106 for LTM. The second cell 1106 is a non-serving cell of the UE 1102. Referring to FIGS. 9 and 10, the UE 902 may monitor a reference signal associated with one or more partially active TCI states (e.g., SSB c1,1 in FIG. 10) of a second cell (candidate cell #1 906) for LTM. The second cell (candidate cell #1 906) is a non-serving cell of the UE 902. In some aspects, 1310 may be performed by the partial TCI activation component 198.

At 1314, the UE may perform the LTM handover to change the serving cell from the first cell to the second cell in response to an LTM command indicating an LTM handover and based on at least one of the partially active TCI states and the active TCI states. For example, referring to FIG. 11, the UE 1102 may perform, at 1122, the LTM handover to change the serving cell from the first cell 1104 to the second cell 1106 in response to an LTM command indicating an LTM handover and based on at least one of the partially active TCI states and the active TCI states. Referring to FIGS. 9 and 10, the UE 902 may perform the LTM handover to change the serving cell from the first cell (serving cell 904) to the second cell (candidate cell #1 906) in response to an LTM command indicating an LTM handover and based on at least one of the partially active TCI states (e.g., SSB c1,1 in FIG. 10) and the active TCI states (e.g., SSB s1 in FIG. 10). In some aspects, 1314 may be performed by the partial TCI activation component 198.

In some aspects, at 1304, the UE may be further configured to transmit a first indication of a first support for an exchange rate between one active TCI state and a first number of partially active TCI states. For example, referring to FIG. 11, the UE 1102 may be further configured to transmit, at 1110, a first indication of a first support for an exchange rate between one active TCI state and a first number of partially active TCI states. In some aspects, 1304 may be performed by the partial TCI activation component 198.

In some aspects, the reference signal may include a synchronization signal of the non-serving cell. For example, referring to FIG. 11, when the UE 1102 monitors, at 1116, the reference signal of the second cell 1106 through one or more partially active TCI state, the reference signal may include a synchronization signal of the non-serving cell (e.g., the second cell 1106).

In some aspects, the synchronization signal may include an SSB or a CSI-RS. For example, referring to FIG. 11, when the UE 1102 monitors the reference signal of the second cell 1106 through one or more partial TCI states at 1116, the synchronization signal may include an SSB or a CSI-RS.

In some aspects, the total number of one or more partially active TCI states may not be more than a partial-state threshold supported by the UE. For example, referring to FIG. 11, when the UE 1102 monitors the reference signal of the second cell 1106 through one or more partially active TCI states at 1116, the total number of partially active TCI states may not be more than a partial-state threshold supported by the UE 1102.

In some aspects, at 1306, the UE may be further configured to transmit a second indication of a second support for the partial-state threshold based on a total number of partially active TCI states supported by the UE. For example, referring to FIG. 11, the UE 1102 may be further configured to transmit, at 1112, a second indication of a second support for the partial-state threshold based on a total number of partially active TCI states supported by the UE 1102. In some aspects, 1306 may be performed by the partial TCI activation component 198.

In some aspects, the partial-state threshold may be based on a first UE capability to support a first maximum number of partially active TCI states for LTM purposes per CC or across multiple CCs.

In some aspects, the partial-state threshold may depend on a CC associated with the UE. For example, referring to FIG. 11, the partial-state threshold (which the UE 1102 transmits at 1112) may depend on a CC associated with the UE 1102.

In some aspects, the partial-state threshold may be across multiple CCs associated with the UE. For example, referring to FIG. 11, the partial-state threshold (which the UE 1102 transmits at 1112) may be across multiple CCs associated with the UE 1102.

In some aspects, the LTM handover may be an intra-frequency LTM handover or an inter-frequency LTM handover, and the partial-state threshold may be different for the intra-frequency LTM handover than for the inter-frequency LTM handover. For example, referring to FIG. 11, when the UE 1102 performs LTM handover at 1122, the LTM handover may be an intra-frequency LTM handover or an inter-frequency LTM handover, and the partial-state threshold (which the UE 1102 transmits at 1112) may be different for the intra-frequency LTM handover than for the inter-frequency LTM handover.

In some aspects, at 1308, the UE may be further configured to, prior to being configured to monitor the reference signal, deactivate, in response to a second number of the active TCI states of the first cell reaching a full-state threshold, at least one active TCI state of the one or more active TCI states of the first cell, where a third number of partially active TCI states is no more than the first number multiplied by a number of deactivated active TCI states. For example, referring to FIG. 11, the UE 1102 may be further configured to, prior to being configured to monitor the reference signal (at 1116), in response to a second number of the active TCI states of the first cell reaching a full-state threshold, deactivate, at 1114, at least one active TCI state of the one or more active TCI states of the first cell. Referring to FIGS. 9 and 10, the UE 902 may, prior to being configured to monitor the second cell (candidate cell #1 906), deactivate at least one active TCI state (e.g., SSB s2 in FIG. 10) of the one or more active TCI states of the first cell (serving cell 904). In some aspects, 1308 may be performed by the partial TCI activation component 198.

In some aspects, the full-state threshold may be based on a second UE capability to support a second maximum number of active TCI states across multiple candidate cells or multiple serving cells.

In some aspects, the time difference between the start time for monitoring the reference signal of the second cell and a receiving time of the LTM command may be more than a time gap. The time gap may be a fourth number of slots, and the fourth number may be based on a frequency band of the UE and is based on the first cell or the second cell. For example, referring to FIGS. 9 and 10, the start time (14 in FIG. 10) for monitoring the reference signal of the second cell (candidate cell #1 906) may be more than a time gap (e.g., a fourth number of slots) before receiving the LTM command (12 in FIG. 10). The fourth number may depend on a frequency band of the UE 902 and is based on the first cell (serving cell 904) or the second cell (candidate cell #1 906).

In some aspects, at 1312, the UE may be further configured to receive the reference signal from the second cell associated with the one or more partially active TCI states of the second cell. For example, referring to FIG. 11, the UE 1102 may be further configured to receive, at 1120, a reference signal (e.g., a TRS) from the second cell 1106 associated with the one or more partially active TCI states of the second cell 1106. In some aspects, 1312 may be performed by the partial TCI activation component 198.

In some aspects, the reference signal may be a TRS or a signal associated with PDCCH or PDSCH. For example, referring to FIG. 11, the reference signal the UE 1102 receives from the second cell 1106, at 1120, may be a TRS or a signal associated with PDCCH or PDSCH.

In some aspects, to perform the LTM handover to change the serving cell, the UE may be configured to: in response to the LTM command being received before the one or more partially active TCI states, perform the LTM handover based on the active TCI states of the first cell. For example, referring to FIG. 11, the UE may be configured to perform the LTM handover, at 1122, based on the active TCI states of the first cell 1104.

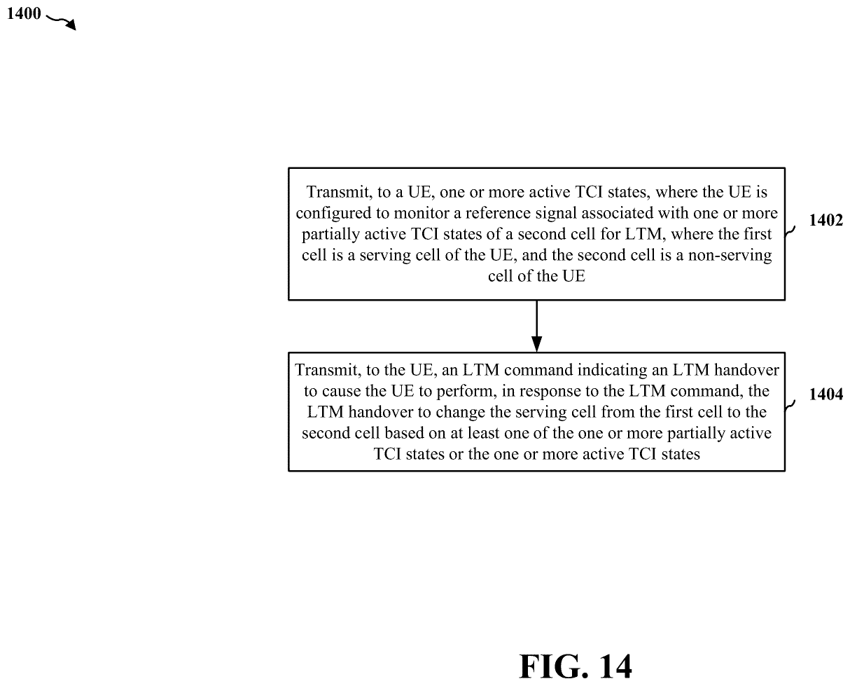

FIG. 14 is a flowchart 1400 illustrating methods of wireless communication at a first cell in accordance with various aspects of the present disclosure. The first cell may be a base station, or a component of a base station, in the access network of FIG. 1 or a core network component (e.g., base station 102, 310; serving cell 904; first cell 1104; or the network entity 1602 in the hardware implementation of FIG. 16). The method enables a UE to use a partially active TCI state to monitor a reference signal of candidate cells for LTM. It substantially reduces the LTM HO delay and interruption length during an LTM HO. Hence, it improves the efficiency of wireless communication.

As shown in FIG. 14, at 1402, the first cell may transmit, to a UE, one or more active TCI states. The UE may be configured to monitor a reference signal associated with one or more partially active TCI states of a second cell for LTM. The first cell may be a serving cell of the UE, and the second cell is a non-serving cell of the UE. The UE may be the UE 104, 350, 902, 1102, or the apparatus 1604 in the hardware implementation of FIG. 16. FIGS. 9, 10, and 11 illustrate various aspects of the steps in connection with flowchart 1400. For example, referring to FIG. 11, the first cell 1104 may transmit to a UE 1102, at 1108, one or more active TCI states. The UE 1102 may be configured to monitor, at 1116, a reference signal associated with one or more partially active TCI states of a second cell 1106 for LTM. The first cell 1104 may be a serving cell of the UE 1102, and the second cell 1106 may be a non-serving cell of the UE 1102. In some aspects, 1402 may be performed by the partial TCI activation component 199.

At 1404, the first cell may transmit, to the UE, an LTM command indicating an LTM handover to cause the UE to perform, in response to the LTM command, the LTM handover to change the serving cell from the first cell to the second cell based on at least one of the partially active TCI states and the active TCI states. For example, referring to FIG. 11, the first cell 1104 may transmit to the UE, at 1118, an LTM command indicating an LTM handover to cause the UE 1102 to perform, at 1122, in response to the LTM command, the LTM handover to change the serving cell from the first cell 1104 to the second cell 1106 based on at least one of the partially active TCI states and the active TCI states. In some aspects, 1404 may be performed by the partial TCI activation component 199.

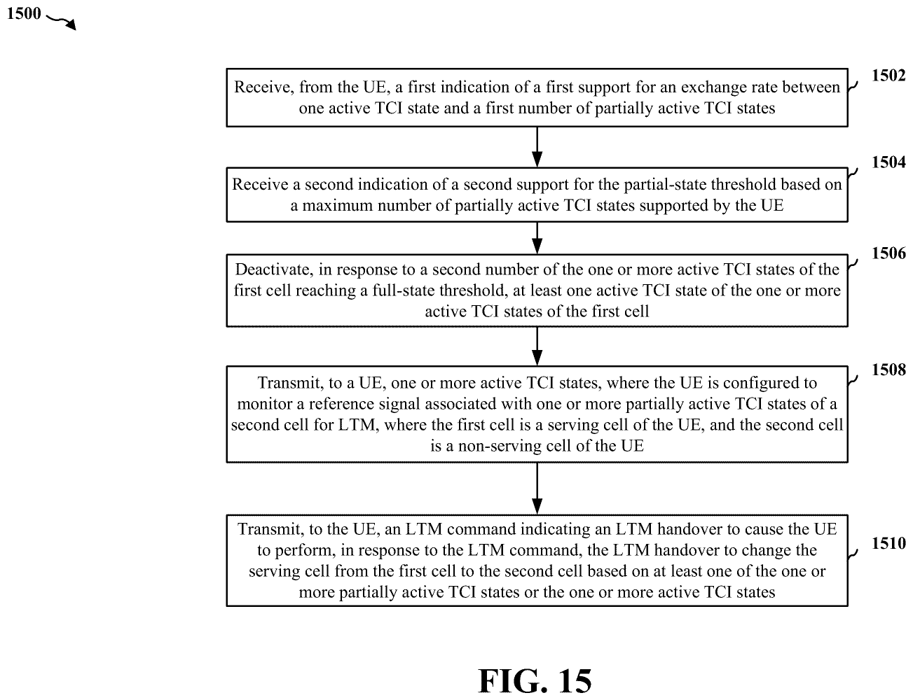

FIG. 15 is a flowchart 1500 illustrating methods of wireless communication at a first cell in accordance with various aspects of the present disclosure. The first cell may be a base station, or a component of a base station, in the access network of FIG. 1 or a core network component (e.g., base station 102, 310; serving cell 904; first cell 1104; or the network entity 1602 in the hardware implementation of FIG. 16). The method enables a UE to use a partially active TCI state to monitor a reference signal of candidate cells for LTM. It substantially reduces the LTM HO delay and interruption length during an LTM HO. Hence, it improves the efficiency of wireless communication.

As shown in FIG. 15, at 1508, the first cell may transmit, to a UE, one or more active TCI states. The UE may be configured to monitor a reference signal associated with one or more partially active TCI states of a second cell for LTM. The first cell may be a serving cell of the UE, and the second cell is a non-serving cell of the UE. The UE may be the UE 104, 350, 902, 1102, or the apparatus 1604 in the hardware implementation of FIG. 16. FIGS. 9, 10, and 11 illustrate various aspects of the steps in connection with flowchart 1500. For example, referring to FIG. 11, the first cell 1104 may transmit to a UE 1102, at 1108, one or more active TCI states. The UE 1102 may be configured to monitor, at 1116, a reference signal associated with one or more partially active TCI states of a second cell 1106 for LTM. The first cell 1104 may be a serving cell of the UE 1102, and the second cell 1106 may be a non-serving cell of the UE 1102. In some aspects, 1508 may be performed by the partial TCI activation component 199.

At 1510, the first cell may transmit, to the UE, an LTM command indicating an LTM handover to cause the UE to perform, in response to the LTM command, the LTM handover to change the serving cell from the first cell to the second cell based on at least one of the partially active TCI states and the active TCI states. For example, referring to FIG. 11, the first cell 1104 may transmit to the UE, at 1118, an LTM command indicating an LTM handover to cause the UE 1102 to perform, at 1122, in response to the LTM command, the LTM handover to change the serving cell from the first cell 1104 to the second cell 1106 based on at least one of the partially active TCI states and the active TCI states. In some aspects, 1510 may be performed by the partial TCI activation component 199.

In some aspects, at 1502, the first cell may be configured to receive, from the UE, a first indication of a first support for an exchange rate between one active TCI state and a first number of partially active TCI states. For example, referring to FIG. 11, the first cell 1104 may be configured to receive from the UE 1102, at 1110, a first indication of a first support for an exchange rate between one active TCI state and a first number of partially active TCI states. In some aspects, 1502 may be performed by the partial TCI activation component 199.

In some aspects, the reference signal may include a synchronization signal of the non-serving cell. For example, referring to FIG. 11, when the UE 1102 monitors a reference signal of the second cell 1106 through one or more partially active TCI states at 1116, the reference signal may include a synchronization signal of the non-serving cell (e.g., the second cell 1106).

In some aspects, the synchronization signal may include an SSB or a CSI-RS. For example, referring to FIG. 11, when the UE 1102 monitors the reference signal of the second cell 1106 through one or more partial TCI states at 1116, the reference signal may include the synchronization signal, which may include an SSB or a CSI-RS.

In some aspects, the total number of partially active TCI states may not be more than a partial-state threshold supported by the UE. For example, referring to FIG. 11, when the UE 1102 monitors the reference signal of the second cell 1106 through one or more partially active TCI states at 1116, the total number of partially active TCI states may not be more than a partial-state threshold supported by the UE 1102.

In some aspects, at 1504, the first cell may be further configured to receive a second indication of a second support for the partial-state threshold based on a total number of partially active TCI states supported by the UE. For example, referring to FIG. 11, the first cell 1104 may be further configured to receive, at 1112, a second indication of a second support for the partial-state threshold based on a total number of partially active TCI states supported by the UE 1102. In some aspects, 1504 may be performed by the partial TCI activation component 199.

In some aspects, the partial-state threshold may depend on a CC associated with the UE. For example, referring to FIG. 11, the partial-state threshold (which the UE 1102 transmits at 1112) may depend on a CC associated with the UE 1102.

In some aspects, the partial-state threshold may be across multiple CCs associated with the UE. For example, referring to FIG. 11, the partial-state threshold (which the UE 1102 transmits at 1112) may be across multiple CCs associated with the UE 1102.

In some aspects, the LTM handover may be an intra-frequency LTM handover or an inter-frequency LTM handover, and the partial-state threshold may be different for the intra-frequency LTM handover than for the inter-frequency LTM handover. For example, referring to FIG. 11, when the UE 1102 performs LTM handover at 1122, the LTM handover may be an intra-frequency LTM handover or an inter-frequency LTM handover, and the partial-state threshold (which the UE 1102 transmits at 1112) may be different for the intra-frequency LTM handover than for the inter-frequency LTM handover.

In some aspects, at 1506, the first cell may be further configured to, prior to being configured to transmit the LTM command, deactivate, in response to a second number of the active TCI states of the first cell reaching a full-state threshold, at least one active TCI state of the one or more active TCI states of the first cell. For example, referring to FIG. 11, the first cell 1104 may be further configured to, prior to being configured to transmit the LTM command (at 1118), in response to a second number of the active TCI states of the first cell reaching a full-state threshold, deactivate (at 1114) at least one active TCI state of the one or more active TCI states of the first cell 1104. Referring to FIGS. 9 and 10, the first cell (serving cell 904) may deactivate at least one active TCI state (e.g., SSB s2 in FIG. 10) of the one or more active TCI states of the first cell (serving cell 904). In some aspects, 1506 may be performed by the partial TCI activation component 199.

In some aspects, the time difference between the start time for monitoring the reference signal and the transmit time for the LTM command may be more than a time gap. The time gap may be a fourth number of slots, where the fourth number is based on the frequency band of the UE and is based on the first cell or the second cell. For example, referring to FIG. 11, the start time (t₄ in FIG. 10) for monitoring the reference signal of the second cell (candidate cell #1 906) may be more than a time gap (e.g., a fourth number of slots) before the LTM command (t₂ in FIG. 10). The fourth number may depend on a frequency band of the UE 902 and is based on the first cell (serving cell 904) or the second cell (candidate cell #1 906).

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor (or processing circuitry) 1624 (also referred to as a modem) coupled to one or more transceivers 1622 (e.g., cellular RF transceiver). The cellular baseband processor(s) (or processing circuitry) 1624 may include at least one on-chip memory (or memory circuitry) 1624′. In some aspects, the apparatus 1604 may further include one or more subscriber identity modules (SIM) cards 1620 and at least one application processor (or processing circuitry) 1606 coupled to a secure digital (SD) card 1608 and a screen 1610. The application processor(s) (or processing circuitry) 1606 may include on-chip memory (or memory circuitry) 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) (or processing circuitry) 1624 communicates through the transceiver(s) 1622 via one or more antennas 1680 with the UE 104 and/or with an RU associated with a network entity 1602. The cellular baseband processor(s) (or processing circuitry) 1624 and the application processor(s) (or processing circuitry) 1606 may each include a computer-readable medium/memory (or memory circuitry) 1624′, 1606′, respectively. The additional memory modules 1626 may also be considered a computer-readable medium/memory (or memory circuitry). Each computer-readable medium/memory (or memory circuitry) 1624′, 1606′, 1626 may be non-transitory. The cellular baseband processor(s) (or processing circuitry) 1624 and the application processor(s) (or processing circuitry) 1606 are each responsible for general processing, including the execution of software stored on the computer-readable medium/memory (or memory circuitry). The software, when executed by the cellular baseband processor(s) (or processing circuitry) 1624/application processor(s) (or processing circuitry) 1606, causes the cellular baseband processor(s) (or processing circuitry) 1624/application processor(s) (or processing circuitry) 1606 to perform the various functions described supra. The cellular baseband processor(s) (or processing circuitry) 1624 and the application processor(s) (or processing circuitry) 1606 are configured to perform the various functions described supra based at least in part of the information stored in the memory (or memory circuitry). That is, the cellular baseband processor(s) (or processing circuitry) 1624 and the application processor(s) (or processing circuitry) 1606 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1624/application processor(s) (or processing circuitry) 1606 when executing software. The cellular baseband processor(s) (or processing circuitry) 1624/application processor(s) (or processing circuitry) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) (or processing circuitry) 1624 and/or the application processor(s) (or processing circuitry) 1606, and in another configuration, the apparatus 1604 may be the entire UE (e.g., see UE 350 of FIG. 3) and include the additional modules of the apparatus 1604.

As discussed supra, the component 198 may be configured to monitor a first cell through one or more active TCI states of the first cell, where the first cell is a serving cell of the UE; monitor a reference signal associated with one or more partially active TCI states of a second cell for LTM, where the second cell is a non-serving cell of the UE; and perform, in response to an LTM command indicating an LTM handover, and based on at least one of the partially active TCI states and the active TCI states, the LTM handover to change the serving cell from the first cell to the second cell. The component 198 may be further configured to perform any of the aspects described in connection with the flowcharts in FIG. 12 and FIG. 13, and/or performed by the UE 1102 in FIG. 11. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for monitoring a first cell through one or more active TCI states of the first cell, where the first cell is a serving cell of the UE, means for monitoring a reference signal associated with one or more partially active TCI states of a second cell for LTM, where the second cell is a non-serving cell of the UE, and means for performing, in response to an LTM command indicating an LTM handover, and based on at least one of the partially active TCI states and the active TCI states, the LTM handover to change the serving cell from the first cell to the second cell. The apparatus 1604 may further include means for performing any of the aspects described in connection with the flowcharts in FIG. 12 and FIG. 13, and/or aspects performed by the UE 1102 in FIG. 11. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

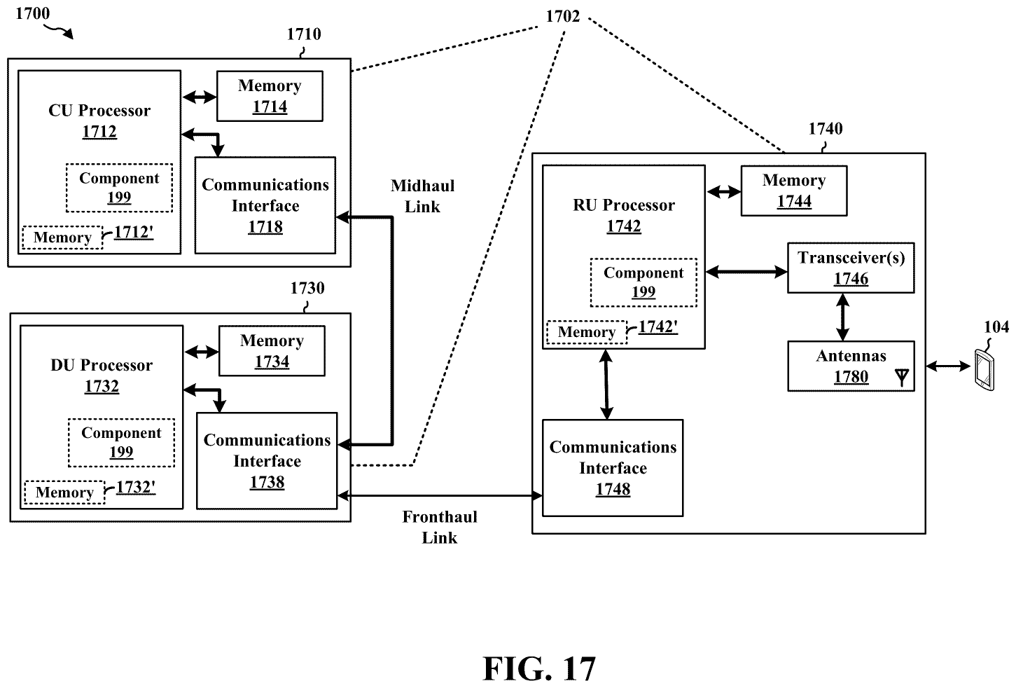

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor (or processing circuitry) 1712. The CU processor(s) (or processing circuitry) 1712 may include on-chip memory (or memory circuitry) 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor (or processing circuitry) 1732. The DU processor(s) (or processing circuitry) 1732 may include on-chip memory (or memory circuitry) 1732′. In some aspects, the DU 1730 may further include additional memory modules 1734 and a communications interface 1738. The DU 1730 communicates with the RU 1740 through a fronthaul link. The RU 1740 may include at least one RU processor (or processing circuitry) 1742. The RU processor(s) (or processing circuitry) 1742 may include on-chip memory (or memory circuitry) 1742′. In some aspects, the RU 1740 may further include additional memory modules 1744, one or more transceivers 1746, antennas 1780, and a communications interface 1748. The RU 1740 communicates with the UE 104. The on-chip memory (or memory circuitry) 1712′, 1732′, 1742′ and the additional memory modules 1714, 1734, 1744 may each be considered a computer-readable medium/memory (or memory circuitry). Each computer-readable medium/memory (or memory circuitry) may be non-transitory. Each of the processors (or processing circuitry) 1712, 1732, 1742 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, one or more active TCI states, where the UE is configured to monitor a reference signal associated with one or more partially active TCI states of a second cell for LTM, where the first cell is a serving cell of the UE, and the second cell is a non-serving cell of the UE; and transmit, to the UE, an LTM command indicating an LTM handover to cause the UE to perform, in response to the LTM command, the LTM handover to change the serving cell from the first cell to the second cell based on at least one of the partially active TCI states and the active TCI states. The component 199 may be further configured to perform any of the aspects described in connection with the flowcharts in FIG. 14 and FIG. 15, and/or performed by the first cell 1104 in FIG. 11. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for transmitting, to a UE, one or more active TCI states, where the UE is configured to monitor a reference signal associated with one or more partially active TCI states of a second cell for LTM, where the first cell is a serving cell of the UE, and the second cell is a non-serving cell of the UE, and means for transmitting, to the UE, an LTM command indicating an LTM handover to cause the UE to perform, in response to the LTM command, the LTM handover to change the serving cell from the first cell to the second cell based on at least one of the partially active TCI states and the active TCI states. The network entity 1702 may further include means for performing any of the aspects described in connection with the flowcharts in FIG. 14 and FIG. 15, and/or aspects performed by the first cell 1104 in FIG. 11. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include monitoring a first cell through one or more active TCI states of the first cell, where the first cell is a serving cell of the UE; monitoring a reference signal associated with one or more partially active TCI states of a second cell for LTM, where the second cell is a non-serving cell of the UE; and performing, in response to an LTM command indicating an LTM handover, and based on at least one of the partially active TCI states and the active TCI states, the LTM handover to change the serving cell from the first cell to the second cell. The method enables a UE to use a partially active TCI state to monitor a reference signal of candidate cells for LTM. It substantially reduces the LTM HO delay and interruption length during an LTM HO. Hence, it improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include monitoring a first cell through one or more active TCI states of the first cell, where the first cell is a serving cell of the UE; monitoring a reference signal associated with one or more partially active TCI states of a second cell for LTM, where the second cell is a non-serving cell of the UE; and performing the LTM handover to change the serving cell from the first cell to the second cell in response to an LTM command indicating an LTM handover and based on at least one of the one or more partially active TCI states or the one or more active TCI states.

Aspect 2 is the method of aspect 1, where the method may further include transmitting a first indication of a first support for an exchange rate between one active TCI state and a first number of partially active TCI states.

Aspect 3 is the method of any of aspects 1 to 2, where the reference signal may include a synchronization signal of the non-serving cell

Aspect 4 is the method of aspect 3, where the synchronization signal may include an SSB or a CSI-RS.

Aspect 5 is the method of any of aspects 2 to 4, where the total number of the one or more partially active TCI states may not be more than a partial-state threshold supported by the UE.

Aspect 6 is the method of aspect 5, where the method may further include transmitting a second indication of a second support for the partial-state threshold based on a maximum number of partially active TCI states supported by the UE.

Aspect 7 is the method of aspect 5, where the partial-state threshold is based on a first UE capability to support a first maximum number of partially active TCI states for LTM purposes per CC or across multiple CCs.

Aspect 8 is the method of any of aspects 5 to 6, where the partial-state threshold may depend on a CC associated with the UE.

Aspect 9 is the method of any of aspects 5 to 6, where the partial-state threshold may be across multiple CCs associated with the UE.

Aspect 10 is the method of aspect 5, where the LTM handover may be an intra-frequency LTM handover or an inter-frequency LTM handover, and the partial-state threshold may be different for the intra-frequency LTM handover than for the inter-frequency LTM handover.

Aspect 11 is the method of any of aspects 2 to 10, where the method may further include: prior to monitoring the reference signal, in response to a second number of the one or more active TCI states of the first cell reaching a full-state threshold, deactivating at least one active TCI state of the one or more active TCI states of the first cell. The third number of partially active TCI states is no more than the first number multiplied by a number of deactivated active TCI states.

Aspect 12 is the method of aspect 11, where the full-state threshold is based on a second UE capability to support a second maximum number of active TCI states across multiple candidate cells or multiple serving cells.

Aspect 13 is the method of aspect 11, where the time difference between the start time for monitoring the reference signal and the receiving time of the LTM command is more than a time gap.

Aspect 14 is the method of aspect 13, where the gap time is a fourth number of slots, and the fourth number is based on the first cell or the second cell.

Aspect 15 is the method of aspect 13, where the method may further include receiving the reference signal from the second cell associated with the one or more partially active TCI states of the second cell.

Aspect 16 is the method of aspect 15, where the reference signal may be a TRS or a signal associated with PDCCH or PDSCH.

Aspect 17 is the method of aspect 1, where performing the LTM handover to change the serving cell may include: in response to the LTM command being received before the one or more partially active TCI states, performing the LTM handover based on the active TCI states of the first cell.

Aspect 18 is an apparatus for wireless communication at a UE, comprising: a processing system that includes processor circuitry and memory circuitry that stores code and is coupled with the processor circuitry, the processing system configured to cause the UE to perform the method of one or more of aspects 1-17.

Aspect 19 is an apparatus for wireless communication at a UE, comprising: at least one memory; and at least one processor coupled to the at least one memory and, where the at least one processor, individually or in any combination, is configured to perform the method of any of aspects 1-17.

Aspect 20 is the apparatus for wireless communication at a UE, comprising means for performing each step in the method of any of aspects 1-17.

Aspect 21 is an apparatus of any of aspects 18-20, further comprising a transceiver configured to receive or to transmit in association with the method of any of aspects 1-17.

Aspect 22 is a computer-readable medium (e.g., a non-transitory computer-readable medium) storing computer executable code at a UE, the code when executed by at least one processor causes the at least one processor to, individually or in any combination, perform the method of any of aspects 1-17.

Aspect 23 is a method of wireless communication at a first cell. The method may include transmitting, to a UE, one or more active TCI states, where the UE is configured to monitor a reference signal associated with one or more partially active TCI states of a second cell for LTM, the first cell is a serving cell of the UE, and the second cell is a non-serving cell of the UE; and transmitting, to the UE, an LTM command indicating an LTM handover to cause the UE to perform, in response to the LTM command, the LTM handover to change the serving cell from the first cell to the second cell based on at least one of the one or more partially active TCI states or the one or more active TCI states.

Aspect 24 is the method of aspect 23, where the method may further include receiving, from the UE, a first indication of a first support for an exchange rate between one active TCI state and a first number of partially active TCI states.

Aspect 25 is the method of aspect 24, where the reference signal may include a synchronization signal of the non-serving cell.

Aspect 26 is the method of aspect 25, where the synchronization signal may include an SSB or a CSI-RS.

Aspect 27 is the method of any of aspects 24 to 26, where the total number of the one or more partially active TCI states may not be more than a partial-state threshold supported by the UE.

Aspect 28 is the method of aspect 27, where the method may further include receiving a second indication of a second support for the partial-state threshold based on a maximum number of partially active TCI states supported by the UE.

Aspect 29 is the method of any of aspects 27 to 28, where the partial-state threshold may depend on a CC associated with the UE.

Aspect 30 is the method of any of aspects 27 to 28, where the partial-state threshold may be across multiple CCs associated with the UE.

Aspect 31 is the method of aspect 27, where the LTM handover may be an intra-frequency LTM handover or an inter-frequency LTM handover, and the partial-state threshold may be different for the intra-frequency LTM handover than for the inter-frequency LTM handover.

Aspect 32 is the method of any of aspects 24 to 31, where the method may further include: prior to transmitting the LTM command, in response to a second number of the one or more active TCI states of the first cell reaching a full-state threshold, deactivating at least one active TCI state of the one or more active TCI states of the first cell.

Aspect 33 is the method of aspect 32, where the time difference between the start time for monitoring the reference signal and the transmit time of the LTM command is more than a time gap, where the time gap is may be a fourth number of slots. The fourth number may be based on the first cell or the second cell.

Aspect 34 is an apparatus for wireless communication at a first cell, comprising: a processing system that includes processor circuitry and memory circuitry that stores code and is coupled with the processor circuitry, the processing system configured to cause the first cell to perform the method of one or more of aspects 23-33.

Aspect 35 is an apparatus for wireless communication at a first cell, comprising: at least one memory; and at least one processor coupled to the at least one memory and, where the at least one processor, individually or in any combination, is configured to perform the method of any of aspects 23-33.

Aspect 36 is the apparatus for wireless communication at a first cell, comprising means for performing each step in the method of any of aspects 23-33.

Aspect 37 is an apparatus of any of aspects 34-36, further comprising a transceiver configured to receive or to transmit in association with the method of any of aspects 23-33.

Aspect 38 is a computer-readable medium (e.g., a non-transitory computer-readable medium) storing computer executable code at a first cell, the code when executed by at least one processor causes the at least one processor to, individually or in any combination, perform the method of any of aspects 23-33.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
monitor a first cell through one or more active transmission configuration indication (TCI) states of the first cell, wherein the first cell is a serving cell of the UE;
monitor a reference signal associated with one or more partially active TCI states of a second cell for lower-layer triggered mobility (LTM), wherein the second cell is a non-serving cell of the UE; and
perform, in response to an LTM command indicating an LTM handover, and based on at least one of the one or more partially active TCI states or the one or more active TCI states, the LTM handover to change the serving cell from the first cell to the second cell.

2. The apparatus of claim 1, further comprising a transceiver coupled to the at least one processor, wherein to monitor the first cell, the at least one processor, individually or in any combination, is configured to cause the UE to monitor the first cell via the transceiver, and wherein the at least one processor, individually or in any combination, is further configured to cause the UE to:
transmit a first indication of a first support for an exchange rate between one active TCI state and a first number of partially active TCI states.

3. The apparatus of claim 2, wherein the reference signal comprises a synchronization signal of the non-serving cell.

4. The apparatus of claim 3, wherein the synchronization signal comprises a synchronization signal block (SSB) or a channel state information reference signal (CSI-RS).

5. The apparatus of claim 2, wherein a total number of the one or more partially active TCI states is not more than a partial-state threshold supported by the UE.

6. The apparatus of claim 5, wherein the at least one processor, individually or in any combination, is further configured to cause the UE to:
transmit a second indication of a second support for the partial-state threshold based on a maximum number of partially active TCI states supported by the UE.

7. The apparatus of claim 5, wherein the partial-state threshold is based on a first UE capability to support a first maximum number of partially active TCI states for LTM purposes per component carrier (CC) or across multiple CCs.

8. The apparatus of claim 5, wherein the partial-state threshold depends on a component carrier (CC) associated with the UE.

9. The apparatus of claim 5, wherein the partial-state threshold is across multiple component carriers (CCs) associated with the UE.

10. The apparatus of claim 5, wherein the LTM handover is an intra-frequency LTM handover or an inter-frequency LTM handover, and the partial-state threshold is different for the intra-frequency LTM handover than for the inter-frequency LTM handover.

11. The apparatus of claim 2, wherein the at least one processor, individually or in any combination, is further configured to cause the UE to, prior to being configured to monitor the reference signal:
deactivate, in response to a second number of the one or more active TCI states of the first cell reaching a full-state threshold, at least one active TCI state of the one or more active TCI states of the first cell, wherein a third number of partially active TCI states is no more than the first number of partially activated TCI states multiplied by a number of deactivated active TCI states.

12. The apparatus of claim 11, wherein the full-state threshold is based on a second UE capability to support a second maximum number of active TCI states across multiple candidate cells or multiple serving cells.

13. The apparatus of claim 11, wherein a time difference between a start time for monitoring the reference signal and a receiving time of the LTM command is more than a time gap.

14. The apparatus of claim 13, wherein the time gap is a fourth number of slots, and the fourth number of slots is based on the first cell or the second cell.

15. The apparatus of claim 13, wherein the at least one processor, individually or in any combination, is further configured to cause the UE to:
receive the reference signal from the second cell associated with the one or more partially active TCI states of the second cell.

16. The apparatus of claim 15, wherein the reference signal is a tracking reference signal (TRS) or a signal associated with physical downlink control channel (PDCCH) or physical data shared channel (PDSCH).

17. The apparatus of claim 1, wherein to perform the LTM handover to change the serving cell, the at least one processor, individually or in any combination, is configured to cause the UE to:
perform, in response to the LTM command being received before the one or more partially active TCI states, the LTM handover based on the one or more active TCI states of the first cell.

18. An apparatus for wireless communication at a first cell, comprising:
at least one memory; and
at least one processor coupled to the at least one memory and, based at least in part on information stored in the at least one memory, the at least one processor, individually or in any combination, is configured to cause the first cell to:
transmit, to a user equipment (UE), one or more active transmission configuration indication (TCI) states, wherein the UE is configured to monitor a reference signal associated with one or more partially active TCI states of a second cell for lower-layer triggered mobility (LTM), wherein the first cell is a serving cell of the UE, and the second cell is a non-serving cell of the UE; and
transmit, to the UE, an LTM command indicating an LTM handover to cause the UE to perform, in response to the LTM command, the LTM handover to change the serving cell from the first cell to the second cell based on at least one of the one or more partially active TCI states or the one or more active TCI states.

19. The apparatus of claim 18, wherein the at least one processor, individually or in any combination, is further configured to cause the first cell to:
receive, from the UE, a first indication of a first support for an exchange rate between one active TCI state and a first number of partially active TCI states.

20. The apparatus of claim 19, wherein the reference signal comprises a synchronization signal of the non-serving cell.

21. The apparatus of claim 20, wherein the synchronization signal comprises a synchronization signal block (SSB) or a channel state information reference signal (CSI-RS).

22. The apparatus of claim 19, wherein a total number of the one or more partially active TCI states is not more than a partial-state threshold supported by the UE.

23. The apparatus of claim 22, wherein the at least one processor, individually or in any combination, is further configured to cause the first cell to:
receive a second indication of a second support for the partial-state threshold based on a maximum number of partially active TCI states supported by the UE.

24. The apparatus of claim 22, wherein the partial-state threshold depends on a component carrier (CC) associated with the UE.

25. The apparatus of claim 22, wherein the partial-state threshold is across multiple component carriers (CCs) associated with the UE.

26. The apparatus of claim 22, wherein the LTM handover is an intra-frequency LTM handover or an inter-frequency LTM handover, and the partial-state threshold is different for the intra-frequency LTM handover than for the inter-frequency LTM handover.

27. The apparatus of claim 19, wherein the at least one processor, individually or in any combination, is further configured to cause the first cell to, prior to being configured to transmit the LTM command:
deactivate, in response to a second number of the one or more active TCI states of the first cell reaching a full-state threshold, at least one active TCI state of the one or more active TCI states of the first cell.

28. The apparatus of claim 27, wherein a time difference between a start time for monitoring the reference signal and a transmit time of the LTM command is more than a time gap, wherein the time gap is a fourth number of slots, and the fourth number of slots is based on the first cell or the second cell.

29. A method of wireless communication at a user equipment (UE), comprising:
monitoring a first cell through one or more active transmission configuration indication (TCI) states of the first cell, wherein the first cell is a serving cell of the UE;
monitoring a reference signal associated with one or more partially active TCI states of a second cell for lower-layer triggered mobility (LTM), wherein the second cell is a non-serving cell of the UE; and
performing, in response to an LTM command indicating an LTM handover, and based on at least one of the one or more partially active TCI states or the one or more active TCI states, the LTM handover to change the serving cell from the first cell to the second cell.

30. A method of wireless communication at a first cell, comprising:
transmitting, to a user equipment (UE), one or more active transmission configuration indication (TCI) states, wherein the UE is configured to monitor a reference signal associated with one or more partially active TCI states of a second cell for lower-layer triggered mobility (LTM), wherein the first cell is a serving cell of the UE, and the second cell is a non-serving cell of the UE; and
transmitting, to the UE, an LTM command indicating an LTM handover to cause the UE to perform, in response to the LTM command, the LTM handover to change the serving cell from the first cell to the second cell based on at least one of the one or more partially active TCI states and the one or more active TCI states.
